(19) United States
(12) Patent Application Publication
(10) Pub. No.: US 2021/0240836 A1
(43) Pub. Date: Aug. 5, 2021

(54) SYSTEM AND METHOD FOR SECURING ELECTRONIC CORRESPONDENCE

(71) Applicant: DCOYA LTD., Sdei Hemed (IL)

(72) Inventors: Yariv HAZONY, Kefar Sava (IL); Ivgeni Broitman, Kfar Yona (IL); Asaf Kotsel, Shoham (IL)

(73) Assignee: DCOYA LTD., Sdei Hemed (IL)

(21) Appl. No.: 17/050,493

(22) PCT Filed: Apr. 17, 2019
(86) PCT No.: PCT/IL2019/050439

§ 371 Date: Oct. 26, 2020

Related U.S. Application Data
(60) Provisional application No. 62/663,273, filed on Apr. 27, 2018.

(51) Int. Cl. G06F 21/57; G06F 21/55; G06F 21/71; G06F 11/34

(52) U.S. Cl. CPC G06F 21/577; G06F 11/3438; G06F 21/71; G06F 21/552

(57) ABSTRACT

A system and method for training a user with respect to security of information may include monitoring interaction of a user with a user's computing device to update a user's information security profile and selecting, based on the profile and based on an event, to perform an action related to the user, the action selected such that is raises the awareness of the user to security of information.

### FIELD OF THE INVENTION

The present invention relates generally to securing electronic correspondence. More specifically, the present invention relates to interacting with a user based on identifying undesirable correspondence.

### BACKGROUND OF THE INVENTION

Phishing is a fraud, cybercrime or attack in which an attacker attempts to obtain sensitive data via a computer system. Phishing typically includes sending emails, text messages or other typically computer-based or network-based correspondence by an attacker who masquerades as a legitimate or reputable entity, an interaction of a recipient with a phishing message can provide the attacker with sensitive or private data such as usernames and passwords, banking and credit card details etc.

### SUMMARY OF THE INVENTION

An embodiment for training a user may include monitoring interaction of a user with a user's computing device to update a user's information security profile; and selecting, based on the profile and based on an event, to perform an action related to the user, wherein the action is selected such that is raises the awareness of the user to security of information.

An embodiment may receive, from an information security system (ISS), information related to an action taken by the user or by the ISS with relation to the user; and based on the action, an embodiment may perform at least one of: inform the user regarding the action, guide the user in responding to the action, force the user to perform an action and prevent the user from performing an action.

An embodiment may select, based on an event and based on the profile, a training session for the user. An embodiment may present, and monitor completion of, a security training session, the training session designed to raise the user's awareness to security, and an embodiment may update the profile based a result of the session. An embodiment may update the profile according to information obtained from an ISS.

An embodiment may intervene in an interaction of the user with the computing device based on at least one of: a violation of a security policy, information received, information about to be sent, a user's profile and a user's score. An embodiment may associate a user with a security score and select an action to perform based on the score.

An embodiment may chat with a user and provide guidance related to security issues. An embodiment may cause an ISS to modify rules related to the user. An embodiment may remind a user to perform an action related to a security threat caused by an action of the user. An embodiment may modify a graphical user interface (GUI) object in an application according to a security consideration.

An embodiment may establish a communication channel between at least one of: a security management personnel and a user, and an ISS and the user. An embodiment may be included in a user's computing device. Other aspects and/or advantages of the present invention are described herein.

### BRIEF DESCRIPTION OF THE DRAWINGS

Non-limiting examples of embodiments of the disclosure are described below with reference to figures attached hereto that are listed following this paragraph. Identical features that appear in more than one figure are generally labeled with a same label in all the figures in which they appear.

A label labeling an icon representing a given feature of an embodiment of the disclosure in a figure may be used to reference the given feature. Dimensions of features shown in the figures are chosen for convenience and clarity of presentation and are not necessarily shown to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows high level block diagram of a computing device according to illustrative embodiments of the present invention;

FIG. 2 is an overview of a system according to illustrative embodiments of the present invention;

FIG. 3 is an overview of a system according to illustrative embodiments of the present invention; and

FIG. 4 shows a flowchart of a method according to illustrative embodiments of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

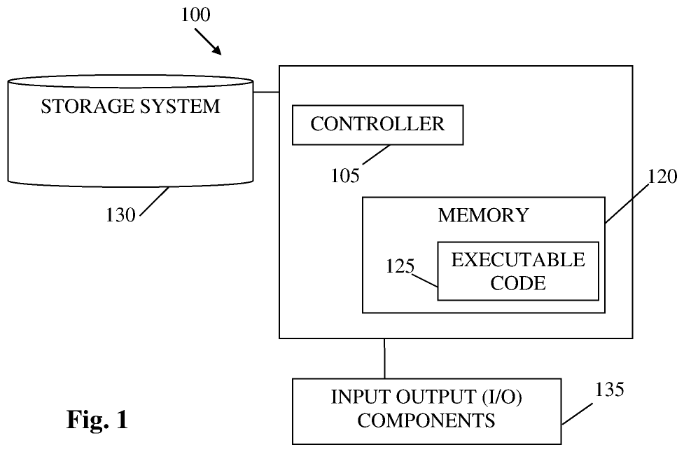

Reference is made to FIG. 1, showing a non-limiting, high-level block diagram of a computing device or system 100 that may be used to identify, characterize and prevent phishing attacks according to some embodiments of the present invention. Computing device 100 may include a controller 105 that may a hardware controller. For example, computer hardware processor or hardware controller 105 may be, or may include, a central processing unit processor (CPU), a chip or any suitable computing or computational device. Computing system 100 may include a memory 120, executable code 125, a storage system 130 and input/output (I/O) components 135. Controller 105 (or one or more controllers or processors, possibly across multiple units or devices) may be adapted or configured (e.g., by executing software or code) to carry out methods described herein, and/or to execute or act as the various modules, units, etc., for example by executing software or by using dedicated circuitry. More than one computing devices 100 may be included in, and one or more computing devices 100 may be, or act as the components of, a system according to some embodiments of the invention.

Memory 120 may be a hardware memory. For example, memory 120 may be, or may include machine-readable media for storing software e.g., a Random-Access Memory (RAM), a read only memory (ROM), a memory chip, a Flash memory, a volatile and/or non-volatile memory or other suitable memory units or storage units. Memory 120 may be or may include a plurality of, possibly different memory units. Memory 120 may be a computer or processor non-transitory readable medium, or a computer non-transitory storage medium, e.g., a RAM. Some embodiments may include a non-transitory storage medium having stored thereon instructions which when executed cause the processor to carry out methods disclosed herein.

Executable code 125 may be an application, a program, a process, task or script. A program, application or software as referred to herein may be any type of instructions, e.g., firmware, middleware, microcode, hardware description language etc. that, when executed by one or more hardware processors or controllers 105, cause a processing system or device (e.g., system 100) to perform the various functions described herein.

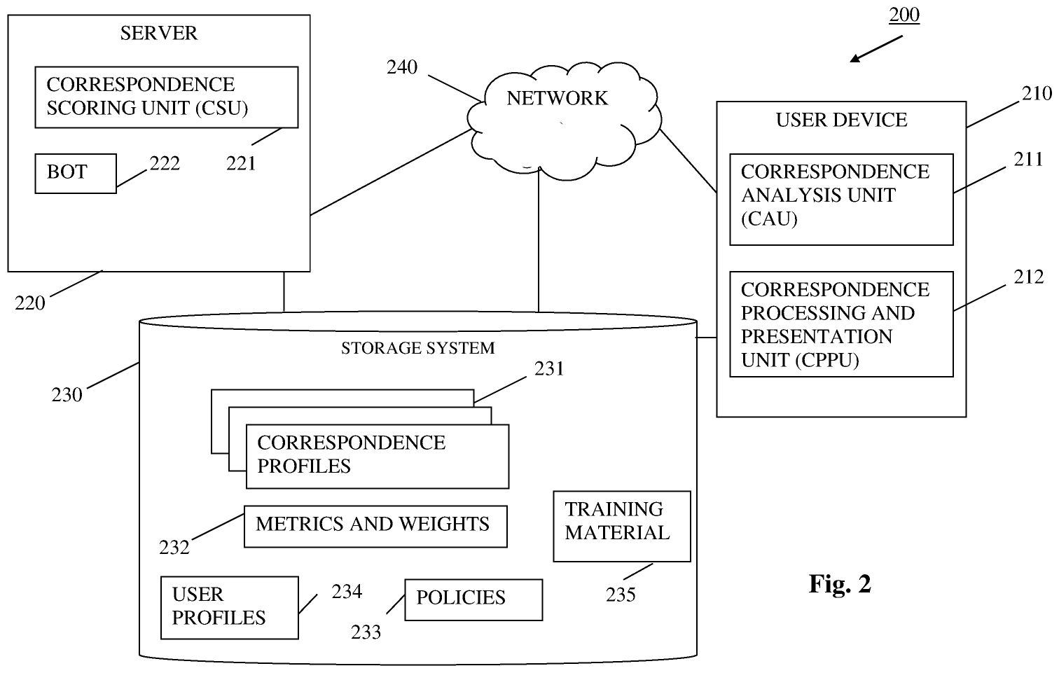

Executable code 125 may be executed by controller 105 possibly under control of an operating system. For example, executable code 125 may be an application that identifies, characterizes and prevents phishing attacks as further described herein. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein. For example, units or modules described herein, e.g., as shown in FIG. 2 and described herein, may be, or may include, controller 105, memory 120 and executable code 125.

Storage system 130 may be or may include, for example, a hard disk drive, a CD-Recordable (CD-R) drive, a Blu-ray disk (BD), a universal serial bus (USB) device or other suitable removable and/or fixed storage unit. Content may be loaded from storage system 130 into memory 120 where it may be processed by controller 105. For example, correspondence profiles, metrics, weights and policies may be loaded into memory 120 and used for identifying, characterizing and preventing phishing attacks as further described herein.

In some embodiments, some of the components shown in FIG. 1 may be omitted. For example, memory 120 may be a non-volatile memory having the storage capacity of storage system 130. Accordingly, although shown as a separate component, storage system 130 may be embedded or included in system 100, e.g., in memory 120.

I/O components 135 may be, may be used for connecting (e.g., via included ports) or they may include: a mouse; a keyboard; a touch screen or pad or any suitable input device. I/O components may include one or more screens, touchscreens, displays or monitors, speakers and/or any other suitable output devices. Any applicable I/O components may be connected to computing device 100 as shown by I/O components 135, for example, a wired or wireless network interface card (NIC), a universal serial bus (USB) device or an external hard drive may be included in I/O components 135.

A system according to some embodiments of the invention may include components such as, but not limited to, a plurality of central processing units (CPU) or any other suitable multi-purpose or specific processors, controllers, microprocessors, microcontrollers, field programmable gate arrays (FPGAs), programmable logic devices (PLDs) or application-specific integrated circuits (ASIC). A system according to some embodiments of the invention may include a plurality of input units, a plurality of output units, a plurality of memory units, and a plurality of storage units. A system may additionally include other suitable hardware components and/or software components. In some embodiments, a system may include or may be, for example, one or more a wireless computing device, e.g., a smartphone, a personal computer, a desktop computer, a laptop computer, a workstation, a server computer, a network device, or any other suitable computing device.

Reference is made to FIG. 2, an overview of a system 200 according to some embodiments of the present invention. As shown, a system 200 may include a user device 210 that includes a correspondence analysis unit (CAU) 211 and a correspondence processing and presentation unit (CPPU) 212. A system 200 may further include a server 220 that may include a correspondence scoring unit (CSU) 221 and a bot 222. Bot 222 may be for example an autonomous software program that when executed can interact with humans users, e.g., bot 222 may be a software program that, mimicking a human, responds to input from users, provides tips and suggestions, answers questions and the like.

As further shown, system 200 may include a storage system 230 that may be, or may be similar to, storage system 130. As shown, storage system 230 may be operatively connected to server 220 and/or to network 240. As shown, storage system 230 may include correspondence profiles 231, metrics and weights 232, policies 233, user profiles 234 and training material 235. Correspondence profiles 231, metrics and weights 232 and policies 233 may be any object or construct usable for storing digital information and for extracting digital information therefrom, e.g., correspondence profiles 231, metrics and weights 232 and policies 233 may be files or they may be tables or lists in a database.

Training material 235 may include any data, information or program that may be used for training users with respect to information security. For example, training material 235 may include presentations, recorded lectures and the like. Training material 235 may include, or be used for, conducting interactive sessions, e.g., an interactive session conducted by an embodiment may include presenting questions to a user, receiving answers or responses from the user and recording a score based on responses of the user. As further described herein, a training session for a user may be automatically selected, e.g., based on a score of the user or based on an action of the user, e.g., if an action of a user is identified as a risky action that may cause leak of sensitive information from an organization then an embodiment may automatically select a specific training session for the user and may force the user to complete the training session.

Correspondence profiles 231 may be collectively referred to hereinafter as correspondence profiles 231 or individually, as a correspondence profile 231, merely for simplicity purposes. Similarly, policies 233 may be individually referred to herein as a policy 233 and metrics or weights 232 may be individually referred to herein as a metric 232 or a weight 232. Although a single user device 210 is shown in FIG. 2 it will be understood that any number of such user devices may be included in a system. Likewise, any number of serves 220 and/or storage systems 230 may be included in a system according to some embodiments of the invention. For example, in an embodiment may include many of user devices 210 that may be computers and/or smartphones of employees in an organization.

Network 240 may be, may comprise or may be part of a private or public IP network, or the internet, or a combination thereof Additionally, or alternatively, network 240 may be, comprise or be part of a global system for mobile communications (GSM) network. For example, network 240 may include or comprise an IP network such as the internet, a GSM related network and any equipment for bridging or otherwise connecting such networks as known in the art. In addition, network 240 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a local, regional, or global communication network, a satellite communication network, a cellular communication network, any combination of the preceding and/or any other suitable communication means. Accordingly, numerous elements of network 240 are implied but not shown, e.g., access points, base stations, communication satellites, GPS satellites, routers, telephone switches, etc. Accordingly, network 240 may enable any number of user devices 210, storage systems 230 and/or servers 220 to communicate. It will be recognized that embodiments of the invention are not limited by the nature of network 240.

System 200 or components of system 200 may include components such as those shown in FIG. 1. Where applicable, modules or units described herein, may be similar to, or may include components of, device 100 described herein. For example, CAU 211, CPPU 212 and CSU 221 may be, or may include, a controller 105, memory 120 and executable code 125.

In some embodiments, CAU 211 is installed, by an organization, in user devices 210. For example, CAU 211 may be, or may include, an email client or a plugin, e.g., in a web browser. Accordingly, users of devices 210 can use their devices, mail programs or applications as they did prior to installation of CAU 211.

In some embodiments, CAU 211 analyzes some or even all messages in a user's e-mail mailbox, including deleted, archived or any other messages in a mail program, application, system or platform. In some embodiments, analysis of mail messages is performed based on metrics 232. For example, CAU 211 retrieves values, parameters or other data from metrics and weights 232 (or data therein is sent to CAU 211 by server 220) and CAU 211 analyzes and scores messages based on the data in metrics and weights 232. In some embodiments, analysis results produced by CAU 211 are sent to server 220 that may store them, e.g., in a correspondence profile 231 or in a global object in a database.

Information, data, values and parameters in metrics and weights 232 may include any data usable for characterizing or classifying messages. For example, metrics and weights 232 may include definitions of what to look at, or search for, in messages, how to score content and the like. For example, metrics and weights 232 may include metrics and weights related to linguistics and writing style aspects, e.g., count and type of: characters, letters, capital letters, digits, non-alphanumeric characters, punctuations, words, unique words, phrases, long words, short words, sentences, average number of words per sentence, etc. Each of the linguistics and writing style aspects indicated in metrics and weights 232 may be associated with a weight or score and one or more thresholds, e.g., if the average number of words per sentence in a message is below a threshold, or proper punctuations are missing, then a high score may be associated with the message.

Other metrics or aspects indicated in metrics and weights 232 and used when analyzing messages may be a language being used, order of word and sentence, e.g., does message start with greeting and/or end with greeting? Metrics and weights 232 may be, or may include any rule, criteria or logic that may be used for scoring messages. For example, a low score may be associated with a message if it starts with greeting and/or ends with greeting, a low score may be given to a message if street or informal language is used, spelling and/or grammar mistakes are found and so on. In other examples, specific writing styles, stationary (e.g., fonts or decorations) and/or signatures (e.g., ones known to be used by attackers) found in a message may cause CAU 211 or CSU 221 to associate a message with a specific score.

Other metrics or aspects indicated in metrics and weights 232 may be related to content in messages, e.g., image, whether an attachment is being sent with an email message and if so, the type attachment. Specifically, CAU 211 or CSU 221 may analyze content of each specific attachment, e.g., based on the type of the attachment, for example, text (e.g., in Word documents) is analyzed. Rules, criteria or thresholds may be used for analysis and scoring of content, e.g., finding or identifying specific words, phrases or language in content causes CAU 211 or CSU 221 to score messages according to rules, criteria or thresholds in metrics and weights 232.

For example, scoring or classifying a message based on metrics may be based on finding, in the message, patterns, phrases or data such as bank account numbers, passwords, promotion text, call to action and the like all of which may be indicated and/or represented (and associated with thresholds, logic and weights) in metrics and weights 232. Other elements in content that may be identified and used in scoring, ranking or classifying a message may be links (e.g., unique resource locators (URLs)) and content identified using sentiment analysis (“positive messaging”, “demanding”, etc.). Any part of a message may be analyzed, e.g., headers may be searched for display name spoofing, domain lookalike. SPF, DKIM, and DMARC analysis across all received mail may be performed. Scoring or classifying a message may include analysis of metadata, e.g., scoring may be based on: time of sending a message; physical location of a sender or recipient; device name and type of sender or receiver etc.

Any rules or criteria may be included in metrics and weights 232, for example, different scores or weights may be associated with, or given to, messages based on parties to a correspondence, division in an organization, geographic location, country and so on. For example, a message received by the head of a department in an organization may be flagged or scored as related to phishing while the very same message, when received by an engineer in the department may be flagged or scored as legitimate. Similarly, a first scoring or classification of a message may be set when received by an employee in the marketing department and a second, different, scoring or classification for the same message may be set when received by an employee in the research and development (R&D) department.

Values or data included in metrics and weights 232 may be related to correspondence and/or participants. For example, a first metric or weight may be associated with a correspondence that includes or involves a senior executive (e.g., one who has access to, and thus may share, very sensitive information) and a second, possibly lower metric or weight may be associated with a correspondence that includes low seniority employees but does not include any senior executives. Metrics may be defined, created and/or updated based on an interaction with 3^{rd} party, external or remote systems. For example, a metric that may influence an automated decision related to blocking specific content may be updated based on a warning from an AV system. Metrics may be defined and/or updated based on a result or outcome of simulations and/or educational activity. For example, a metric that represent susceptibility to phishing attacks may be updated, e.g., to reflect that a user has passed a training session, failed or succeeded a test (e.g., a simulation of a phishing attack) and so on.

In some embodiments, CAU 211 sends analysis results (possibly accompanied by analyzed messages) to server 220. It will be noted that some of the analysis results may be produced by server 220, e.g., using CSU 221. Server 220 may build a database of conversations with their respective metrics, scores, classification or other information produced as described. For example, correspondence profiles 231 may include, for each specific sender and receiver, a profile. Each profile may be associated with a set of metrics or values that uniquely identifies and/or characterizes the correspondence between a sender and receiver. Accordingly, after a correspondence is characterized, a new or subsequent message can be quickly classified. For example, based on a profile 231 of a correspondence (e.g., an email message) with an employee in an organization can be quickly, e.g., in real-time, be classified as either a phishing attempt or a legitimate message. It is noted that profiling as described may be for a single user and/or for a pair of sender/receiver, e.g., a specific employee in an organization can be profiled in a correspondence profile 231 and the profile can be used to determine whether or not messages received by the employee are related to an attack or malicious entity and, in other cases, a pair of sender/receiver can be profiled in a correspondence profile 231 and messages received by the receiver from the sender can be classified or categorized based on the profile.

As described, scoring or classifying messages, e.g., classifying or scoring a message as a potential phishing attempt, may be based on metrics and associated weights. For example, and as described, each metric is associated with a weight, and a score or classification of a message is done by identifying metrics in the message and, using weights of the metric, associating the message with a score or classification. As further described, metrics and weights may be set or defined based on various aspects, e.g., sender, receiver, location, time etc. In some embodiments, metrics and weights may be dynamically and/or automatically adjusted thus enabling a system to adjust to new or evolving situations or conditions. For instance, if an employee moves from one position to another (e.g., promoted to be head of a department), or changes his laptop, some of the employee's metrics and weights are changed by server 220 or by CAU 211 such that the metrics and weights produce the correct score for future messages and/or correspondence.

In some embodiments, each new message is analyzed as described prior to being presented to the recipient. For example, CPPU 212 analyzes each mail message received, associates the message with a score as described and, prior to displaying the message, performs one or more actions based on a score of the message and based on one or more policies in policies 233. For example, email messages with low score (e.g., potential phishing messages) are hidden from the end user by CPPU 212, while emails with medium score are displayed without infected attachments.

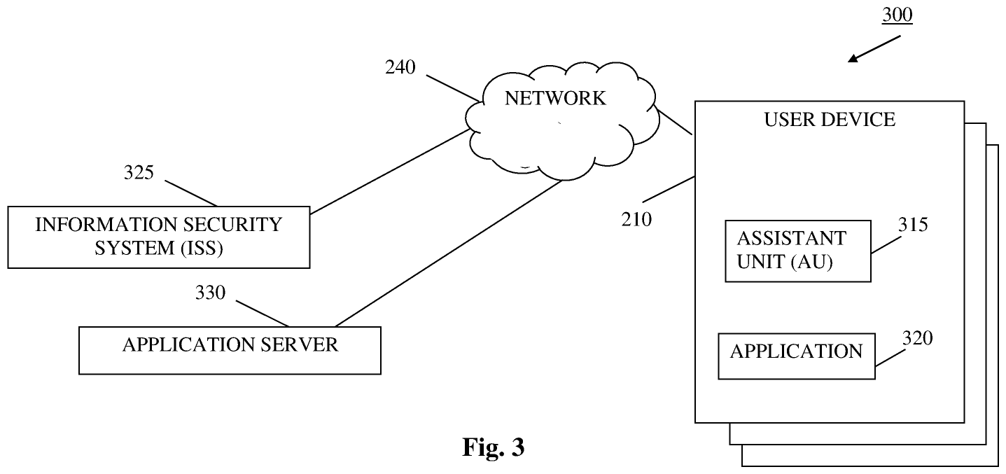

Scoring a message as described may be based on the content of the message. For example, policies 233 and/or information security system 325 (further described herein with reference to FIG. 3) may include source addresses (or domains) of entities suspected of participating in phishing attempts, if, based on analyzing a message and identifying the source of the message it is determined the message may be related to phishing, CPPU 212 may associate the message with a low score or, if the message comes from a known source (e.g., from a subsidiary of a company or from a family relative) CPPU 212 may associate the message with a high score (9 out of 10) indicating the message is safe. Various logic or heuristics may be used for determining a value of a score, e.g., each appearance, in a message received by a user, of one of a set of words or phrases (e.g., “your phone number”, “the email address of your superior” and so on) may cause CPPU 212 to lower a score by a predefined amount. In another example, policies 233 and/or information security system 325 may include words or phrases that, when appearing in a message may indicate phishing, for example, the phrase “please provide our phone number” in a message may cause CPPU 212 to associate the message with a low score (e.g., 2 out of 10) as it may indicate a phishing attempt. In yet another example, a list of people who have been corresponding with a user, e.g., over the last six months, may be kept (e.g., in a user profile 234), accordingly, when an e-mail from someone who has not written (or sent e-mails) to a user in the past or in the last six months is received CPPU 212 may flag the message by associating it with a low score. Yet another example may be related to the time a message was sent, for example, since phishing e-mails are typically sent by bots they may be sent during any time of day, e.g., sent at 02:00 AM local time of the recipient, since it is unlikely that a human will send an e-mail at such a time, a message sent at 02:00 AM may be associated by CPPU 212 with a low score indicating it may be a phishing attempt. To avoid false alarms (or wrongly associating messages with a low score) CPPU 212 may track correspondence of a user, e.g., CPPU 212 may record who the user exchanges e-mails with, thus, if an e-mail from someone with whom the user has never exchanged e-mails in the past is received CPPU 212 may associate the e-mail with a low score, similarly, when an e-mail from someone with whom the user exchanges e-mails regularly is received, CPPU 212 may associate the e-mail message with a high score to indicate the e-mail message is safe. In yet another example, CPPU 212 may associate an e-mail message with a score based on the recipient list of the message, for example, a phishing attempt typically targets many users, thus, in addition to other criteria as described, if CPPU 212 identifies that an e-mail message is addressed to a (possibly large) number of users in an organization CPPU 212 may associate the message with a low score since a large number of recipients may be an indication of spam or phishing. An embodiment may associate messages with scores based on correlating messages received by a number of users in an organization. For example, each CPPU 212 may inform CSU 221 of some or even all messages received by a user and CSU 221 may examine data related to some or even all users in an organization, accordingly, if CSU 221 identifies that many users in an organization all received an e-mail from the same source including the same or similar content, CSU 221 may instruct CPPU 212 units to associate the e-mail with a low score.

In some embodiments, CPPU 212 controls how messages are presented to a user. For example, an explanation or description of a score may be added to each email shown in an inbox so that it is clear why a certain email message is shown as with “low credibility” mark. For example, having blocked an e-mail message, CPPU 212 may present a message to a user saying “e-mail from John Brown was blocked because it is suspected as a phishing attempt, do you/trust know John Brown?”

In some embodiments, CPPU 212 attracts or brings user attention to suspicious (low score) messages such that a user can clearly and readily see all suspicious messages. For example, CPPU 212 may add a highlight effect to suspicious or low scored messages or groups such messages in a specific area.

In some embodiments, CPPU 212 performs various actions including modifying messages. For example, CPPU 212 prevents interaction with suspicious messages (e.g., disables a “Reply” button in a mail program or application), removes links and/or attachments from mail messages and so on. Actions or manipulations performed by CPPU 212 as described may be based on policies 233. For example, a policy may dictate that mails with a score lower than a first threshold are to be highlighted, mails with a score lower than a second threshold are to be modified such that the cannot be replied to or forwarded (thus preventing malicious emails or other messages from reaching additional users or employees in an organization) and so on.

An action performed by an embodiment, e.g., by CPPU 212, may, instead of, or in addition to, changing messages as described, change, configure or modify how email clients (e.g. programs providing access to e-mail messages) work. For example, the ability (or inability) to forward emails is typically based on a configuration of an email client, e.g., the Outlook or Thunderbird programs, in some embodiments, to prevent forwarding of specific emails (e.g., based on a rule, policy or criteria as describe), CPPU 212 automatically configures the email client such that it does not forward specific messages and/or does not open messages, automatically deletes messages and so on.

Generally, data in policies 233 includes settings that control a behavior of the system, including the general look and feel provided to a user. A policy in policies 233 can be per, related to, or used for, a single employee, or it can be used for a group of employees that match a specific criterion, e.g., a policy can be for all employees in an organization, for employees in a specific department of for a specific, one employee. A policy may control or govern various aspects, e.g., visualization of email (e.g., highlighting or grouping of messages) can be based on a policy, actions performed (e.g., blocking emails by CPPU 212 as described) may be based on a policy, sanctions applied and/or notifications that may be sent to an administrator may all be according to, or based on a policy 233.

Some embodiments generate a correspondence map, network or list that includes and/or represents various aspects of correspondences or communications in an organization. For example, in some embodiments, based on scanning mailboxes of employees as described, bot 222 generates a list, table, map or graph (e.g., a directed graph (or digraph)) that maps or represents all senders and recipients (e.g., vertices) and emails exchanged between them (e.g., edges). A list, map, table or graph generated as described can then be used for various purposes. For example, having determined that a first user has received undesirable content on an email, based on the map or graph, bot 222 or a CPPU 212 can proactively block mails from the first user to other users. For example, if the map indicates that the first user sends lots of emails (of a specific content type) to a second user then, upon detecting malicious content in the inbox of the first user, bot 222 prevents sending emails from the first user to the second user. Of course, the example here is a simplified one and far more complex rules and logic may be used in conjunction with a map or graph representing correspondences in an organization. Based on mapping or charting aspects of correspondences in an organization, embodiments of the invention gain in depth knowledge and understanding of characteristics of the correspondences. Accordingly, embodiments of the invention can automatically and proactively act in response to threats, e.g., block paths along which malicious emails messages travel.

A list, table, map or graph as described may include various aspects, layers or groups. For example, a map can include or presented according to groups (e.g., executives, users with high/low permissions etc.) and flows between groups may be shown to a user and/or automatic actions may be performed based on groups. For example, certain types of emails or content may be blocked or prevented from being sent to a group, a group may be prevented from sending specific emails and so on. Any criteria or logic may be used for grouping users, e.g., a first group may include users that tend to send risky attachments, a second group may include users that send a lot of emails with Word format documents attached thereto and so on. An automatic action may be based on a group, for example, bot 222 can block specific mail based on a group, an event and/or a specific content, e.g., upon being alerted that malicious content was found in a Word document (e.g., from one of CAU 211 or from an AV unit), bot 222 blocks correspondence between users who typically exchange Word documents based on a group of such users. By continuously mapping or charting correspondences as described, an embodiment can continuously and dynamically learn and understand how emails or other content is shared or passed between users and therefore the embodiment can continuously, dynamically and proactively protect an organization from undesirable content.

A policy may be created and/or updated for a group or category of users. For example, a policy may be created for a group of users who tend to send risky attachments (e.g., attachments that include sensitive material). Accordingly, a policy may be created, updated, and used, per a group, category or class of users. For example, upon receiving a warning related to an attack that includes using malicious software embedded in Excel format files, a policy created for users who frequently send Excel files may be automatically triggered and cause a system to block correspondence of users associated with the policy. In other cases, a policy may be for a group of users who have specific (e.g., high) privileges or permissions, for example, a successful attack on one or more users who are allowed to modify sensitive data in an organization may be extremely harmful to an organization, accordingly, a policy related to a group or class of privileged users may be created and actions as described herein may be invoked for the class or group of users, e.g., when informed of an attack, a system may automatically disable privileged users from executing 3^{rd} party or other software that accesses sensitive information.

Accordingly, by interacting with external and/or remote systems (e.g., 3^{rd} party systems), an embodiment may predict an attack and may take action to prevent a future attack, e.g., based on information received from deep web research tools or a security information and event management (SIEM) product that warns of a future phishing attack, CAU 211 units may automatically warn employees in an organization (e.g., high score employees for whom a warning is sufficient) and prevent email reception for other employees (e.g., low score employees for whom a warning may not suffice and thus blocking is required). For example, based on a warning received from a 3^{rd} party system that an attack is in progress, a first CAU 211 may block emails for a first user and a second CAU 211 may only warn a second user (but still enable the second user to receive suspicious emails).

In some embodiments, CPPU 212 interacts with a user. For example, CPPU 212 prompts the user to provide input, e.g., CPPU 212 requests a user to verify an email address by displaying “please confirm that your manager's additional email is [manager's email]”, or CPPU 212 notifies a user about events or conditions, e.g., CPPU 212 displays, to a user, “it looks like you receive a lot of emails with low credibility from ‘faulty-domain.com’, mails from this address are marked as low”. CPPU 212 may enable a user to act, e.g., provide a button (e.g., integrated in a mail client program) that enables a user to report suspicious mails to an administrator. For example, CPPU 212 may send notifications to a predefined recipient list using email, short message service (SMS) and the like. It will be understood that any (possibly 3^{rd} party) techniques, methods or systems may be used by embodiments of the invention (e.g., by CAU 211, CPPU 212 and/or CSU 221) when analyzing correspondence and/or searching for threats or malicious messages, for example, malicious links detection methods or systems, attachment analysis systems, antivirus (AV) applications, public or other blacklists that specify specific RBLs, DNS or IP addresses may all be used in analyzing messages as described.

A plurality of systems may collaborate, for example, CAU 211, CPPU 212 and/or CSU 221 in a first system may send and receive data from CAU 211, CPPU 212 and/or CSU 221 in a second system such that data identifying threats is correlated and/or shared across industries, sites, market segments or organizations. In some embodiments, a verification score may be associated with shared or other data. For example, authenticity, integrity or other aspects of files or other content may be verified by a user, e.g., a user who is designated, by an administrator, as a high score user may verify or authenticate an email or content. Verified or authenticated messages or content may be freely distributed, e.g., allowed to be sent or forwarded, by an employee to other employees in an organization. Using a list of verified or authenticated messages and/or content can speed operation, e.g., CAU 211 can skip examining an email if it is marked, in a list, as authenticated. Of course, an embodiment may automatically and/or autonomously authenticate or verify content. For example, having seen the same type of email (e.g., from same sender, with similar content and so on) received by a user twice a week, CAU 211 decides that this type of mail is legitimate and CAU 211 may inform bot 222 that mail with these characteristics is verified or authenticated.

Authenticity, integrity or other safety aspects of data may be verified or vouched for by 3^{rd} party software or systems, e.g., an anti-virus software, CISCO etc. Verification of data may be shared, e.g., based on a verification of content as described, CSU 221 in a first system may inform CAU 211 in a second system that the content is safe, thus true collaboration of units, possibly distributed across many systems, is achieved.

Some embodiments include self-learning or machine learning or adaptation, possibly aided by user input. For example, if a user receives a new email from a new sender every day and indicates this is a legitimate condition or scenario, then a system may after training a machine learning or other process with this input refrain from identifying this condition or scenario as related to threat. In another case, if a user identifies and/or indicates an email as phishing, an embodiment may record that a new email with similar characterization is relate to phishing. Accordingly, self-learning may be based on any scenario, condition or aspect, e.g., frequency of mails, time of day of reception of mails, number of recipients and so on.

A user interface provided by a system may enable a user (e.g., an administrator) to see reports, configure the system, define rules and policies (e.g., “emails coming from ‘some-domain com’ should be deleted”) etc. For example, a dashboard may enable a user to define policies that may be stored in policies 233, see status and events, message scores, attack patterns, generate reports and the like. In some embodiments, a system may suggest new polices to be defined, for example, observing that specific mail types are indicated or identified as phishing, a system may suggest a new policy for such mail types, in another case, observing that a specific set of users frequently receive phishing material from one or more sources, an embodiment may suggest a policy for the set of users and/or for the set of sources.

A system according to some embodiments may, based on users' interactions with messages (e.g. via a user's interaction with a computing device to view and respond to messages), automatically train users and/or automatically configure a security component. For example, a unit may automatically generate or simulate phishing or other messages, automatically send the messages to users in an organization and automatically track and record interactions of users with the generated or simulated phishing or other messages. For example, harmless messages with a look and feel that closely resembles phishing messages may be automatically generated (e.g., by CSU 221) and sent to employees in an organization. The interaction with, or response to, such simulated messages may be automatically recorded (e.g., by one of CAU 211 or CPPU 212) and the recorded interactions may be used to automatically generate an education plan for the organization. In addition, simulated messages and users' responses may be used to automatically configure units or devices. For example, if it is determined that messages with a specific look and feel are typically interacted with by users then a unit (e.g., bot 222) may automatically configure a firewall to block such messages, in other cases, CPPUs 212 are automatically configured to verify the authenticity or otherwise process messages with the specific look and feel based on characteristics of simulated phishing emails that were automatically created and sent as described. Accordingly, an embodiment can continuously, automatically and dynamically, based on users' interactions with emails, train users to better avoid phishing or other emails as well as continuously, automatically and dynamically improve protection of a network from phishing or other malicious emails or content, e.g., by automatically configuring network devices and other units as described.

In some embodiments, a computer-implemented method of securing electronic correspondence comprises generating a plurality of phishing messages and sending the messages to a recipient; recording interactions of the recipient with the messages; and producing risk analysis results based on the interactions. In some embodiments, a computer-implemented method of securing electronic correspondence comprises calculating, based on the interactions, a risk factor for the recipient. In some embodiments, a computer-implemented method of securing electronic correspondence comprises generating additional phishing messages based on the interactions. In some embodiments, a computer-implemented method of securing electronic correspondence comprises configuring a security system based on the interactions.

Bot 222 may be any unit or module, typically software executed by one or more processors, that performs an automated task. For example, bot (or crawler) 222 may analyze users' correspondence to produce analysis results, e.g., analysis results may be produced by bot 222 based on an analysis of users' emails in an organization. For example, in some embodiments, bot 222 accesses mail boxes or accounts of users and analyzes email messages therein, e.g., bot 222 identifies and/or classifies, and includes in analysis results, the content or subject matter being discussed in email messages, records in analysis results, for each mail message, topics discussed, the date and time the mail message was sent and received, the sender and the recipients and so on. In some embodiment, based on analysis results produced as described, an embodiment creates and updates correspondence profiles 231 and/or user profiles 234. In some embodiment, based on analysis results produced as described, an embodiment creates and updates policies 233.

Although FIG. 2 shows bot 222 included in server 220, other configurations may be contemplated. For example, if server 220 includes or stores mail boxes of users in an organization then bot 222 in server 220 may readily examine all emails of all users in the organization, however, in other configurations, instances of bot 222 may be deployed in users' computers and these instances may perform any operation as described herein with respect to bot 222. In yet other embodiments, units or modules (e.g., CAU 211 or CPPU 212 may perform any operation performed by bot 222 as described herein. Although email messages are mainly discussed herein it will be understood that embodiments of the invention may be applicable to any form of correspondence. For example, an embodiment may analyze, profile users, create and update policies and/or act as described herein based on SMS messages exchanged between users, instant messages exchanged between users (e.g., using WhatsApp) and so on. Accordingly, it will be understood that the scope of the invention is not limited by the type of system or method used for correspondence between users.

It will be understood that operations and logic of embodiments of the invention as described herein, e.g., email checking, reporting and highlighting or otherwise marking functionality can be enabled, realized, deployed or implemented, in an organization, by installing a plugin for email clients (e.g., CAU 211 and/or CPPU 212) and/or by directly integrating with an email server (e.g., bot 222 may be integrated into an exchange server). Generally, based on a configuration, any logic or operation described with respect to anyone of server 220, bot 222, CSU 221, CAU 211, CPPU 212 and user device 210 can be performed by any other one of these units or elements.

In some embodiments, bot 222 creates and updates user profiles 234 (which may be or include a security profile) based on analyzing correspondences as described. For example, bot 222 may examine or analyze text in emails or other correspondence and use techniques to identify language descriptors of personality. For example, bot 222 may use the big five personality traits approach or technique or model (also known as the five-factor model (FFM)) to identify and/or classify users. For example, bot 222 may classify or score users according to their openness to experience, conscientiousness, agreeableness and/or neuroticism as known in the art. Any other classification or profiling or users may be used by bot 222. User profiles determined by bot 222 may be stored in user profiles 234. Accordingly, in addition to personality traits identified and recorded in a user profile 234 as described, a profile 234 may be updated according to, or based on correspondence as described and/or based on or according to the behavior (or actions) of the user with respect to phishing or other attacks. An awareness program may be automatically created for users according to user traits, or other aspects or characteristics learned as described.

In some embodiments, bot 222 keeps track (e.g., in a profile 234) of any aspect related to a user in the context of phishing or other attacks. For example, bot 222 records data related to user activities such as interaction with content in a website or email message, sending email or other messages, opening, forwarding, deleting or otherwise manipulating messages and so on.

For example, bot 222 may record, in a user profile 234, the number of times a user has engaged with an email or other message that includes (or is suspected of including) malicious content. For example, each time a user clicks on a banner or message that is (or is suspected as) related to phishing content, bot 222 may record (e.g., in the relevant user profile 234) metadata related to the correspondence (e.g., the relevant web site, the subject of an email, the sender of a message and so on). Phishing content may be any digital content (e.g., in a body of an email message) designed to obtain information from a user. For example, a link or banner in an email message is phishing content as referred to herein.

For example, in some embodiments, based on data in policies 233, bot 222, CAU 210 or CPPU 212 identifies or determines that an email message is related to phishing content (e.g., the source of the message is known or blacklisted) and, if CPPU 212 identifies or determines that the receiving user has opened the message and/or interacted with content in the message (e.g., clicked on a link in an email message) then CPPU 212 updates the user's profile 234, e.g., increments a counter. Any other aspects related to user activities or interactions with content may be detected and recorded, e.g., using a plurality of counters. For example, system 200 records in a profile the number of times a user opened emails that are suspected as phishing, deleted such emails without opening them, forwarded, interacted with, replied to such emails, and so on. By profiling user activities as described, system 200 generates a user profile 234 that reflects, indicates and quantifies how susceptible the user is to phishing or other attacks. An awareness program may be automatically created for users according to user susceptibility learned as described.

By tracking user actions as described and identifying or determining that a first user tends to click on ads or other content that may be related to phishing, bot 222 may mark the first user as one prone to fall victim to phishing attacks, e.g., by including in the user's profile a high vulnerability score (e.g., 9 out of 10) and, identifying or determining that a second user hardly ever clicks on ads or other content that may be related to phishing, bot 222 may include, in the second user's profile 234 a low vulnerability score (e.g., 2 out of 10).

Profiling as described may be based on any applicable aspect. For example, bot 222 may record, in a user profile 234, the number of times the user has been warned (e.g., by CPPU 212) regarding content. For example, having identified that an email received by a user may include clickable or other content designed to obtain sensitive data, CPPU 212 may warn the user if, or when, the user attempts to open the message or to interact with content in the message. For example, if an email received by a user is from an entity known to send phishing messages, CPPU 212 may warn the user that interacting with the message may expose the user to phishing. The action of the user following a warning as described may also be recorded, e.g., in the user's profile 234. Accordingly, the number of warnings as well as the response to the warnings or other related actions of the user may be recorded in the user's profile 234.

Profiling of a user as described may be based on sites visited by the user. For example, the type of sites visited by the user (e.g., related to sports, fashion or politics), domains and/or any other aspects related to web activity may be recorded in the user's profile and an action performed by an embodiment may be based on the user's web activity. For example, and as described, access to specific sites may be blocked for specific users when phishing attacks are launched. For example, informed that an ongoing phishing attack is targeting web sites related to fashion, an embodiment may warn (or even block access to some sites for) a user who, based on data in his/her profile, is fond of such sites.

In some embodiments, profiling of a user is based on a presence of a user in a social network.

For example, bot 222 semantically or otherwise analyzes content in Facebook or Google+, LinkedIn or other social networks to characterize a user and updates the user's profile 234 based on identified fields of interest, personality traits and the like.

In some embodiments, actions performed by an embodiment may be based or selected according to a user profile 234. For example, as described, CPPU 212 may present (e.g., using a popup, embedded content or other methods as known in the art) warnings, or educational or training content to a user. For example, if a user opens an email message that includes content identified as a possible threat then CPPU 212 may present a warning to the user and/or CPPU 212 may present educational content to the user, e.g., CPPU 212 may select to present, to the user, one of a number of texts, e.g., one of: “This message may include content that can jeopardize the security of your firm”, “Interacting with this message may risk your privacy” or “Reporting this message to the IT department may help the organization and may be highly appreciated”.

In some embodiments, the content and/or phrasing of a message presented to a user may be based on the user's profile 234. For example, if the user's profile 234 indicates that the user is (or is the type that is) highly committed to the organization, then the training, warning or educational content selected may be related to the organization or firm (e.g., mention the security of the firm as in the above example), in another case, if the user of the type that responds well to compliments or appreciation, then the training, warning or educational content selected (e.g., by CPPU 212) may mention appreciation as in the above third example text. Accordingly, automatic training of users may be based on their profile, and specifically, based on their respective character or personality.

Training, warning or generating, selecting providing educational content (e.g., by CPPU 212) may be automatic, e.g., performed without an intervention or supervision of an administrator or user.

For example, automatic generation, selection and presentation of educational content may be based on the number of times training, warning or educational content has been presented to the user, e.g., in the past three months and as recorded in the user's profile as described. For example, the first-time educational text is presented the text may include a suggestion, but when a warning or educational text is presented to the user after such or similar text has already been presented several times in the last three weeks, the text may include a warning, or the language used may more assertive than that previously used. Accordingly, an embodiment may automatically and/or autonomously learn security aspects as described and may further automatically generate and provide training, warning or educational content to users.

An action taken by an embodiment may be based on a user profile. For example, when a message (e.g. email) suspected of including phishing is received in an inbox of a user then, if the user has never been warned before, or if the user has responded adequately or correctly to warnings in the past, then an embodiment may only warn the user. However, if the user has been warned a number of times in the past and/or has ignored warnings then an embodiment may block access to a message suspected of including phishing and addressed to or destined for the user. For example, the message may be quarantined as known in the art.

For example, as described, warnings and actions of a user may be recorded in the user's profile 234, specifically, responses to warnings may be recorded in a user's profile. Accordingly, if when previously warned of suspicious content, the user has refrained from interacting with the content (and this may be recorded in the user's profile as described) or if the user has never before been warned that a message may include phishing content then CPPU 212 may warn the user to be cautious but enable to user to view the content, however and as described, if based on data in a user's profile, an embodiment determines that the user has failed to adequately respond to warnings in the past then an embodiment may prevent the user from accessing content. Any other action may be based on a user's profile, e.g., selecting whether or not to alert an administrator, remove or quarantine files and so on may be based on a user profile. Accordingly, an action performed by an embodiment may be based on a user profile.

An action selected or performed may be based on information in any one or more of: profiles 234, correspondence profiles 231, metrics and weights 232 and policies 233 and based on attributes of the content communicated. For example, if an email with an Excel sheet attachment is identified as related to phishing as described, bot 222 may block reception of all emails that include attachments of Excel sheets (e.g., quarantine such emails). For example, bot 222 may command CPPUs 212 in an organization to prevent users from accessing Excel sheet in email messages. In another example, an action may include blocking access to a specific website based on identifying phishing content is related to the specific site, for example, having identified phishing activity as described, bot 222 identifies a site or domain related to the phishing activity and configures a gateway or firewall to prevent access to the site or domain

An embodiment may automatically interact with users based on content and aspects related to a correspondence. For example, an embodiment may identify or determine an answer for a question has been provided and, if an answer to an already answered question is received, an embodiment may interact with the parties concerned, e.g., in order to verify that an answer or respond to a question is not related to phishing or other malicious activity.

For example, CAU 211 may identify a request for payment, e.g., based on detecting words, terms or phrases such as “invoice”, “debit note” or “please complete payment by Jun. 23, 2018” received, by a user in an organization, from a client (e.g., in an email) and may log a number, reference or other identifying information related to the request for payment. CAU 211 may further identify or detect (e.g., by monitoring email traffic as described) a response sent from the user to the client, e.g., a confirmation of payment or a transaction. If, after identifying a response as described, CAU 211 identifies a subsequent or additional request for payment with the same number, reference or other identifying information, then CAU 211 may warn the user that the subsequent or additional request for payment may be related to malicious activity.

For example, the scenario described above may take place when a malicious entity tries to lure the user to pay again for a service or product already paid for, or when a malicious entity tries to cause the user to send payment to the malicious entity instead of (or in addition) to the provider of service or product. For example, in the example above, upon identifying a request for payment for an already paid-for product, CAU 211 may send an email, or otherwise present a warning, e.g., saying “Note that invoice number 137754 has been paid per email of Feb. 5, 2018” thus alerting the user to check whether or not the second or subsequent request for payment is a legitimate one.

In other cases, CAU 211 may identify a response for a request that was never made. For example, upon identifying a request for payment for a service or product for which CAU 211 cannot find any request, or upon identifying a request for payment from a source with whom a user never exchanged emails, CAU 211 may alert the user as described. Any logic or algorithm may be employed by CAU 211 in order to identify an intervention in a business flow, e.g., fraudulent requests for payments as described.

In some embodiments, based on identifying reception or presence of phishing content related to a first user a second user may be interacted with. For example, having determined that John received an email containing phishing content (e.g., bot 222 gets an alert message from CAU 211 in a device used by John), bot 222 may interact with George (e.g., via CAU 211 in a device used by George) and, for example, informs George to beware of emails coming from a specific source. Selecting to interact with George in the above example may be based on a correspondence profile 231 that links John and George and/or based on a match of the profiles 234 of John and George and/or based on a rule in policies 233 and/or based on metrics and weights 232.

In some embodiments, a system may verify correspondence by checking both a source and a destination of the correspondence. For example, in case of a business email compromise (BEC) attack, a bot may check the outgoing and incoming mailbox for email verifications. e.g., if a user receives an email from his chief executive officer (CEO) demanding for urgent payment, the bot may automatically check the CEO mailbox outgoing to verify the existence of the message.

In some embodiments, policies 233 may be created and/or updated automatically. For example, bot 222 may automatically update policies 233 based on information from various sources, e.g., an antivirus definition or alerts, web sites that discuss phishing attacks and so on. For example, informed by an anti-virus application that phishing attempts are launched from a specific domain or email address, bot 222 may automatically update policies 233 such that the domain or email address are included in a black list. A black list may be used by CPPU 212 units, e.g., if an email from a domain included in a black list in policies 233 is received, CPPU 212 may associate the message with a low score as described, may block the message or perform other actions as described.

Automatic update based on external or other sources as described may be for any of: user profiles 234, metrics and weights 232 and policies 233. Policies may be created or updated based on interacting with any unit or system, e.g., 3^{rd} party software or servers. For example, bot 222 may interact or communicate with an anti-virus (AV) unit, software or server inside or even outside an organization and if bot 222 is informed or warned of a virus or malware, e.g., in an email attachment, then bot 222 may automatically perform an action as described, e.g., block or quarantine email messages as described herein. Actions taken by bot 222 may be based on an interaction with any system, unit or module, e.g., bot 222 may interact with an endpoint protection system, an anti-phishing system etc.

In some embodiments, several bots 222, e.g., in a respective several organizations or geographic locations may communicate or interact. For example, bot 222 in a first organization may inform bot 222 in a second organization that a phishing attack or phishing content was identified. Informed by a remote bot 222 that phishing content was received at a remote site or organization, a local bot 222 may perform any action as described, e.g., update any one or more of user profiles 234, metrics and weights 232 and policies 233, configure a network device (e.g., a fire wall) to block specific content or websites etc.

As described, to determine whether or not a correspondence is related to phishing or other malicious activity, an embodiment may analyze the correspondence. For example, bot 222, CAU 211 or another unit in system 200 may compare a logo in an email message signature to the sender's domain and/or to a URL in the email. For example, if the sender is yariv@decoya.com and a logo image in the signature is, or includes, “Dcoya” and/or the domain from which the mail was sent is dcoya.com then CAU 211 may automatically determine that the email was indeed sent by Yariv from Dcoya, however, if the logo includes, “Cisco” or includes other, non-official logo, or the domain from which the mail was sent is not dcoya.com (e.g., it is dicoia.com, from-dcoya.com, dcoyas.com, ddcoya.com etc.) then CAU 211 may determine the email is related to a phishing attempt or other attack, and, as a result, CAU 211 may perform one or more actions as described.

An embodiment may include, exhibit or implement artificial intelligence (AI), neural network, machine learning and/or self-learning as described. For example, computing device 100 may perform machine learning, deep learning or AI, e.g., executable code 125 may be software that implements machine learning or other AI functionality, which may be implemented by a neural network (NN).

A NN may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g. CPUs or graphics processing units (GPUs), or a dedicated hardware device may perform the relevant calculations.

CAU 211 and/or bot 222 may record users' actions and then perform actions based on recorded or learned actions. For example, if a user reports a specific email message as a phishing attempt then CAU 211 may record characteristics of the email (e.g., sender, recipient list, time of day, content attributes and the like) and CAU 211 may further record that the email was classified, by the user, as phishing related, and, when a subsequent email with the same characteristics is received, CAU 211 may automatically classify the email as a phishing attempt and may take action as described. Accordingly, an embodiment may learn how to identify phishing or other attacks from users.

An embodiment may record or map a progress of messages related to an attack and present the map to a user. For example, an email identified as related to phishing received by a first user may be forwarded by the first user to a second user, bot 222 may record forwarding of the email and present to an administrator a map that graphically or otherwise shows how the email propagates through the organization thus enabling the administrator to prevent a current and/or subsequent attack, e.g., by defining policies or rules based on a progress patterns of malicious mails. Accordingly, an embodiment may present, to a user, a map of how an email attack is spreading in an organization, thus allowing the user to stop or prevent an attack. For example, using the map, the administrator can enforce a rule that prevents specific users from receiving or forwarding specific email messages. For example, the map enables an administrator to see which users, departments or groups already received a phishing email and further see in what direction the attack is spreading or progressing, based on such information, the administrator can block the attack, e.g., apply a rule that prevents progress of an email message out of a department or set of users. The map may further enable an administrator to easily and quickly see the type of users that received and/or forwarded an undesirable email or other message, accordingly, a rule defined and enforced by an administrator may be based on users' types or attributes, e.g., a rule may be applicable to users' score, rank, permissions etc. (e.g., as reflected in user profiles 234).

AI and/or self-learning may include using/applying, any knowledge or information acquired, deduced or generated for a first user for/to a second user. For example, when a new employee is registered in a system, an initial profile for the user and/or an initial set of policies or rules for the user may be defined and/or created based on one or more profiles or criteria related to matching employees. For example, matching employees whose profiles or policies may be used may be of the same gender and/or age of the new employee, employees in the department of the new employee, employee in the same country and so on. Any rule or criteria may be used to match a new employee to other employees. In some cases, a profile or other information of a sender may be used to set a rule, criteria or policy for a new employee or new user. For example, when, for the first time, a new employee receives an email from a sender in an organization, an embodiment may use the sender's profile in order to perform an action related to the correspondence of the new employee with the (possibly already known and profiled) sender.

Some embodiments may monitor or track user's actions and, based on user actions, create policies and/or define rules or criteria. For example, in some embodiments, bot 222 tracks and monitors actions of one or more of: a user, an employee, a supervisor, an administrator or a sec-op (e.g., using a key-logger or screen capturing technique) and records actions and related content or correspondences. For example, if bot 222 records that the administrator always marks emails from domain aaa.bbb@ccc.com as phishing related then bot 222 inserts a rule for or creates a policy that prevents emails from domain aaa.bbb@ccc.com from reaching employees in the organization. Accordingly, an embodiment can learn from users and create and apply logic based on users' actions or behavior.

Embodiments of the invention may identify or predict threats coming from inside an organization. For example, by examining emails as described, CAU 211 may learn that an employee is unsatisfied or is about to resign, such employee may be a threat to the organization, accordingly, CAU 211 may inform an administrator that the employee may constitute a security threat or CAU 211 may automatically change the employee's profile, e.g., down grade the security level or score of the employee or CAU 211 may modify a policy or rule, e.g., such that mails previously received by the employee are now blocked. For example, CAU 211 may scan all text in messages sent by an employee and search for specific words, terms or phrases, e.g., “low salary”, “CV”, “fed up”, “annoyed” and “upset”, and, if some of the searched for words, terms or phrases are found, CAU 211 may alert an administrator or other user, e.g., warning that the user may be a risk for the organization.

An embodiment may automatically define and/or create an awareness program for a user based on any aspects related to the user and to the user's susceptibility to phishing or other attacks (e.g., as included in user profile 234). For example, based on analyzing emails and/or other communications or activities (e.g., content shared in a social media), CPPU 212 may determine demographic information of a user (e.g., age, gender and the like), a seniority of the user, fields of interest of the user and/or any other relevant aspects, all of which may be included in the user's profile 234. Based on analyzing emails and/or other communications or activities CPPU 212 may determine susceptibility of a user to phishing or other attacks. An awareness program that includes presentations, questionnaires, sending test email messages and so on may be defined for a user based on his/her profile. For example, metadata associated with elements in training material 235 may indicate, e.g., for each presentation or training session, their respective suitability for different users. For example, a first training session may be best suited, or specifically tailored for females, a second training session may be designed for those who are technically inclined (e.g., includes numeric examples, descriptions of computer operations), a third training session may be designed for younger employees (e.g., includes up to date terms or phrases found in web sites that are popular with young people) and so on. Accordingly, based on data in a user profile 234, an embodiment may automatically select the best training session for a specific user or employee. Of course, a training session may be selected from training material 235 based on actions or behavior of a user, e.g., if the user tends to carelessly respond to emails and/or provide, in emails, information that is best not provided (e.g., phone number and the like) then a training session designed to increase awareness to security aspects related to emails may be selected for the user, in another case, if a user tends to click on banners in web sites then a different training session may be selected from training material 235, e.g., one designed to increase awareness to security aspects when surfing the internet. An awareness program may include a number of sessions selected from training material 235. Accordingly, an awareness program automatically created for a first user (e.g., a female who is working in the organization for 20 years) may be different from an awareness program automatically created for a second user (e.g., a new young, male employee).

As described, an embodiment may interact with users. For example, when a new data loss prevention (DLP) policy is launched in an organization, bot 222 or CPPU 212 may present, to users, relevant training related to the new DLP policy. As described, different presentations (for the same DPL or other policy) may be provided to different users based on their respective profiles 234. An embodiment may interact with users based on any regulations, rule, criteria or policy introduced to, launched in, or adopted by, an organization, for example, when regulations or governance policies such as PCI, HIPPA, SOCX, GPDR are introduced, bot 222 or CPPU 212 may present, to users, relevant training related to the regulations or policies.

Some embodiments automatically modify content or suggest a modification to a user. For example, if based on a DLP rule bot 222 or CAU 211 determines that sensitive information is about to be sent in an email message to a recipient outside an organization then CAU 211 may suggest to a user to modify the message, e.g., remove an attachment, remove some of the text in the message and so on. In some embodiments, e.g., based on a classification or rating of a user, CAU 211 may automatically remove attachments or text from a message thus automatically and dynamically preventing data leakage.

Currently, and as known in the art, the role of training users in an organization so that awareness to phishing and other threats are minimized is done by a chief information security officer (CISO). In addition, the CISO needs to monitor information sent or provided, by users (e.g., sent or provided to entities external to the organization) and ascertain that sensitive information does not leak, this field is referred to in the art as data leakage protection (DLP). When an organization employs dozens, hundreds or event thousands of employees, the task of the CISO (or his/her department) cannot be adequately performed. A CISO in a large organization cannot monitor, for all employees, all emails, text messages and other events or operations that may cause data leakage. Moreover, while training can lead to awareness of users to potential risks, different employees typically need different training, e.g., a first employee may need to be trained to be careful when replying to emails, a second employee may need to be trained to avoid clicking links in a browser and so on. Determining the proper training for each employee in an organization is an overwhelming task that cannot be adequately performed manually.

Currently most of cyber and information security challenges are met by technological solutions such as AV systems, firewalls, data leak prevention (DLP) systems, intrusion prevention systems (IPS), intrusion detection systems (IDS), Web Filtering etc. These solutions cover most of the organizations' attack surface but still a large part of the attack surface remains uncovered, e.g., zero-day (0-day) attacks, credentials harvesting attacks, phishing, web malware scripts etc. cannot be efficiently dealt with by current or known automated systems. Accordingly, organizations need to train their employees with respect to preventing and remediating many forms or types of attacks. For example, employees need to be trained to avoid giving organizational or private credentials in mail request, avoid surfing to unsecure websites, avoid downloading files from specific web sites or open attachments from an unrecognized or unknown senders, remember to pick sensitive printed material from a printer, lock a desktop's screen when leaving their desk and so on.

Training users or (e.g., employees in an organization) to avoid threats and risks described above may include reminding or causing employees to report any suspicious email, open a case with the security department when a PC acts strange and so on. Other training related to information security may include training employees to avoid sending sensitive files or other information to unknown or unauthorized recipients. However, there currently exists no system or method that automatically trains employees, warns users when a risk or threat is suspected, or otherwise raises their awareness to security issues, these challenges are left for the CISO to handle manually, by talking to employees, sending reminders, giving lectures, measuring or evaluating employees level of awareness and the like. In addition, effective training requires focusing on specific employees' roles and department (e g training needed for an employee in the accounting department may be different from training needed for an employee in IT department) currently all of security training solution are one size for all employees.

Further aggravating the problem is the fact that current security solutions typically cause operational overload and business continuity issues. For example, a flow related to DLP may be as follows: a user sends a message that includes sensitive information that violates the organization's policy, the DLP system quarantines or deletes the message, in many cases, without updating or informing the user. Accordingly, the user sometimes doesn't know that his/her mail did not reach its destination, to find that out, the user needs to send an email to, or call support. Accordingly, a DLP system may be delay or slow a business process or flow. In another example related to web browsing: a user may need information from blacklisted website and therefor needs to contact support to exclude the site from the blacklist.

As described herein, embodiments of the invention solve the problems described herein by automating a training process as well as continuously monitoring users' activities and warning users (employees in an organization) regarding attacks or risky behavior. As described, embodiments of the invention may personalize a training for each or specific user, e.g., based on what the user does and/or based on a profile of the user, an embodiment may warn the (specific) user that an action may risk information (e.g., the action may cause sensitive information to fall into the wrong hands), or an embodiment may prevent a user from performing an action and/or an embodiment may force the user to complete a training session.

In addition, and as described, embodiments of the invention enable a CISO to easily send messages (communicate) directly to users, either to a specific user and also to a set of users. Embodiments of the invention enable efficient, easy to use communication between an organization and its employees and vice versa. In some embodiments, communication between an organ of organization (e.g., the CISO) and employees is monitored and a score of an employee (e.g., a value in a profile 234) may be updated according to responsiveness or compliance of a user. For example, if a user does not acknowledge a message from the CISO, the user's score may be decreased.

There currently exists no system or method that can track users' behavior with respect to security, associate users with scores that reflect the level of risk that results from their behavior and automatically select, define, generate and force a training targeted at minimizing security risks. For example, an automated assistant according to some embodiments and as described herein may monitor a user's behavior, identify potentially risky operations or behavior, warn a user of a risky behavior or operation, prevent a user from carrying out an undesirable operation that may risk security of information and, based on a user's behavior, the assistant may select, define and/or generate specific training material for the user and ensure the user is properly trained.

Currently, and as known in the art, the role of training users in an organization so that awareness to information and cyber security, phishing and other threats are minimized is done by a CISO. When an organization employs dozens, hundreds or even thousands of employees, the task of the CISO (or his/her department) cannot be adequately performed. Some training solution use HTML or computer-based training (CBT) methods which require the employees to click on training link (usually received by email) and participate in a training session, however, these methods do not include monitoring of training sessions or determining an outcome of the sessions (e.g., a score, a successful completion of the session and so on). Current solutions are not effective nor do they bring about a real change of behavior, for example, since the cost of having all employees in an organization spend time on trainings (including employees who do not need the training) is high, therefor, trainings are rarely conducted, in addition, trainings that are conducted for a large number of users or employees are typically general in nature are only suitable for some of the users, thus these trainings are ineffective and costly. Moreover, evaluating the results or effectiveness of these trainings requires manually examining the results, per each user, a task that is typically not carried out as it requires substantial time and resources. As described, an assistant according to some embodiments of the inventions solves many of the problems described above, for example, an assistant may monitor a user's behavior and/or interaction with a computer and determine, based on the user's behavior, exactly what kind of specific training the user needs. As further described, an assistant may prevent the user from performing actions that raise a security risk, suggest actions to a user when a potential risk is met and so on.

Embodiments of the invention may improve the technology of computer security in general and of preventing computer data leakage in particular by for example automating the tasks of identifying users who pose a security threat to an organization, identifying, for specific users, the specific threats they pose, and by further selecting specific actions (e.g., training and prevention) for specific users. Embodiments may provide a practical application of computer processes as described herein by providing a unit that tracks, monitors and identifies user behavior (e.g., CPPU 212) and by further providing automatic selection and presentation of training material designed to increase awareness of users to security aspects when using computers. Embodiments may provide a practical application of computer processes as described herein by providing a system that automatically identifies phishing or other malicious attempts, and prevents luring users into providing sensitive information to malicious entities.

Reference is now made to FIG. 3 which shows a system 300 according to some embodiments of the invention. As shown, a system 300 may include network 240 and user device 210 described herein. As further shown, system 300 may include an information security system (ISS) 325 and an application server 330 that may be connected to network 240, accordingly, user device 210 and units, modules or components included in user device 210 may readily communicate, over network 240, with ISS 325 and with application server 330. Of course, ISS 325 may communicate with application server 330 over network 240. As shown, user device 210 may include an assistant unit (AU) 315 and an application 320. ISS 325 may include any 3^{rd} party or other unit, system or component related to security. For example, ISS 325 may include an AV program or system, a set of firewalls that control which information flows in or out of an organization, a unit for generating encryption keys and the like.

AU 315 may be, or may include components of, computing device 100, for example, AU 315 may be, or may include, a controller 105, executable code 125 and a memory 120 as described herein. Application 320 may be a software program as known in the art. In some embodiments, AU 315 may be or may include components and/or logic included in CAU 211 and/or in CPPU 212. Accordingly, it will be understood that any operation performed by CAU 211 and/or in CPPU 212 may be performed by AU 315.

As described, AU 315 may generally replace a CISO or act as a personal CISO. Generally, AU 315 may be thought of as a personal CISO, e.g., AU 315 may monitor user's behavior or actions and select a training for the user based on the user's behavior. For example, if AU 315 detects that, in many cases, the user sends email attachments from a folder that includes confidential documents, AU 315 may select a training designed to raise awareness to sending sensitive information in mail, in another case, if AU 315 detects that the user often copies documents to a removable device (e.g., a USB stick) then AU 315 automatically grab the user attention and may select a training related to carrying, out of the organization's facilities, devices that contain sensitive data. Accordingly, embodiments of the invention provide a user with a personal assistant that learns the user's behavior and trains the user according to the user's behavior.

AU 315 may act to increase users' awareness to security of information. In some embodiments, AU 315 may monitor interaction of a user with a user's computing device and may create and/or update a user's information security profile (e.g., user profile 234) based on the interaction. AU 315 may select, based on a user's profile and/or based on a policy 233 and based on an event, to perform an action related to increasing the user's awareness to security of information.

For example, an event may be a reception of a message (e.g., reception of an email message) or an event may be responding to an email (e.g., responding to a message with a low score as described), an event may be a click on a banner in a website, an event may be connecting (by a user) a USB device to a computer or an event may be sending a document to a printer. An event may be, or be part of, any interaction of a user with a computer. Generally, an interaction of a user with his/her computing device may include sending emails or text messages, clicking on links in a web browser, copying data to a removable storage device (e.g., a USB stick or disk on key), entering information in a web site or application and the like.

For example, AU 315 may monitor any interaction of a user (e.g., sending an email) and, according to interactions of a user, AU 315 may update a user profile 234 that may be stored in a storage system (e.g., storage system 230) or, in some embodiments, a user profile may be stored locally, e.g., on user's computing device 210. Monitoring user interactions may be performed using any system or technique. For example, AU 315 may register, with an operating system (OS) in device 210, to receive data related to any relevant event, e.g., by hooking a kernel as known in the art, in other embodiments, AU 315 may be, or may include a plug-in (e.g., in an email application, OS plug-in etc.) such that any relevant information related to interactions of a user with an email client or application is provided to AU 315. As described, a score may be used to select a training session or otherwise act to increase an employee's, or a user's awareness level (e.g., a score may be used to select a warning to be displayed on a user's screen). For example, when a user's score reaches a threshold, a user may be forced to participate in a training session that specifically targets the user's behavior. For example, if by monitoring user's actions, AU 315 identifies that the user tends to click links in web sites known as risky, AU 315 may select, for that specific user, a training session that deals with safe browsing. Metadata associated with objects in training material 235 may include a description thus AU 315 may readily select a proper training session based on sessions included in training material 235.

In some embodiments or cases, an action taken by AU 315 as described may prevent a security threat or risk, e.g., an action taken by AU 315 may prevent the user from providing sensitive information to an outside entity, when preventing a user from performing an action, AU 315 may immediately explain, to the user, e.g., by displaying a message, what the risk is and AU 315 may additionally suggest an alternative action. For example, identifying a user is about to disclose a bank account number to an unknown or untrusted entity, AU 315 may warn the user and suggest verifying the recipient is indeed trusted.

For example, phishing as known in the art typically includes an attempt to lure a user to provide details such as user name and password combination, personal information, banking data and the like, AU 315 may monitor correspondence involving a user (e.g., receiving data from a 3^{rd} party anti phishing solution), identify a possible or suspected phishing attempts and either prevent the user from falling victim to the phishing attempt (e.g., by preventing the user from clicking on a link or by preventing a user from responding to an email) and/or AU 315 may explain to the user why an email includes a phishing attempt and/or AU 315 may guide the user how to respond to a suspected phishing attempt, e.g., by displaying, on a screen of computing device 210, a message providing suggested action, warning and the like. For example, acting as, or including, a conversational chat-bot, AU 315 may display, on top of screen of an application, any information or message as described.

Accordingly, as viewed by a user, messages from AU 315 may be integrated into applications. As described, relevant training materials may be displayed, by AU 315 based on an event or an interaction of a user, for example, when a phishing is suspected, AU 315 may present a popup that includes training material, e.g., describing risks related to phishing, suggesting to avoid an action that may cause the user to disclose information and so on.

As further described, based on an interaction of a user, e.g., a click on a link in an email, including sensitive data in an email and the like, AU 315 may determine the user needs to be trained and AU 315 may automatically select a training session for the user. AU 315 may determine the user needs to be trained based on a number of considerations that may include, for example, a score associated with the user (e.g., a score included in user profile 234), a policy 233 and a metric or weight 232.

In some embodiments, AU 315 may act to increase awareness of a user to security of information based on a sequence or history of actions of a user. Unlike the actions of a CISO, AU 315 may track actions of a user and react immediately, in real-time, to actions of a user.

For example, AU 315 may detect that an employee tends to click on a dangerous links in emails, websites, popups, and so on. At the first time the user clicks on a dangerous link, AU 315 may use a popup or other technique to comment on such action and/or display some training material, if within a specific or predefined time interval, the employee again clicks a link that may be risky (e.g., according to a policy, black list and the like), AU 315 may highlight the link and/or cause a 3^{rd} party unit to do so and AU 315, in addition to highlighting the link may prompt the user to confirm the link is to be pressed, if, after the second time, the employee again clicks on a dangerous link, AU 315 may prevent the user from further clicking such links or AU 315 may prevent links from being clickable by (or being displayed to) the user. Accordingly, AU 315 may select an action based on a behavior of a user and/or based on a history of actions of the user. For example, by dynamically and automatically updating scores in a user's profile and selecting an action based on a score, a set of actions of the user may enable AU 315 to determine the type of action to select, e.g., select one of: a suggestion; a warning; or a prevention of an action.

For example, following a sequence of risky actions or behavior related to links as described, AU 315 may force a user to participate in a training session related to links and, only if the user successfully completes the training session AU 315 may enable the user or cause a 3^{rd} party unit to do so, to click links as described. For example, the score of a user may be decreased each time the user clicks on a dangerous link as described and, if the score is below a threshold, AU 315 may prevent the user from clicking links in a web browser or other application. If AU 315 determines the user's awareness to security is improved, e.g., the user does not attempt to click risky links for a predefined time interval, AU 315 may raise the user's score and, once the score is above a threshold, AU 315 may again permit or enable the user to click links. As described, AU 315 may continuously, dynamically and automatically monitor and/or determine, for a user, the level or awareness to, or compliance with, security of information and may interact with the user (or intervene the user's actions) according to the level of compliance or awareness. Accordingly, training a user and/or restricting a user from performing actions may be according to how aware the user is to security issues, therefore, embodiments of the invention may increase and improve awareness to security of information, e.g., by escalating the actions taken by AU 315 as described, e.g., from informative actions to preventive actions as described. The advantage of immediate or real-time reaction to user actions will be readily appreciated by a person in the industry, e.g., warning a user not to click a dangerous link when the user clicks the link is far more effective than giving a lecture about dangerous links to an entire department in an organization. By responding to a user's action immediately, in real-time, embodiments of the invention are far more effective and efficient in training user's, an immediate action as described is far superior to an annual lecture on security given to an entire department. Triggered based action (e.g., suggestion, warning or prevention as described) provided by embodiments as described is effective since it provides training for a specific issue and for a specific user, when applicable. The personalized, event or action specific training (or warning, and eventually preventing of an action) enabled by embodiments of the invention (e.g., AU 315) is far superior to any method or technique currently used, e.g., lectures and brochures currently used by CISO's to increase awareness.

In some embodiments, AU 315 associates a user with a security score and selects an action to perform based on the score. In some embodiments, AU 315 may associate each user in an organization with a score and AU 315 may continuously and dynamically modify or update users' scores. Associating users with scores may include, for example, including a value in each of users' profiles 234. AU 315 may associate each user with a number of scores for a respective number of security aspects. For example, a first score may reflect the level of risk with respect to emails, a second score may be related to surfing the internet, a third score may be related to communication over an instant messaging or chat application and so on. It will be noted that user device 210 may be, for example, a smartphone or other mobile communication device and AU 315 may monitor (and act according to) interactions of a user with the mobile communication device. As further described, AU 315 may select how to assist or train a user based on the user's score or profile, for example, AU 315 on a first computing device of a first user may, when the user is about to send an email, warn the user regarding some of the recipients (e.g., if the user's score is high) and a second AU 315, on a second computing device of a second user may, in a similar scenario or condition, prevent the user from sending the email, and/or require or force the user to complete a training since the score of the second user is low.

For example, AU 315 may associate a user with an initial email score of 100 and may decrease the user's email score each time the user violates a policy related to email, e.g., a policy 233 may indicate that including (in an email, as an attachment) a file from a specific folder in a server of an organization is undesirable, accordingly, if the user attaches the file to an outgoing mail, AU 315 may decrease the user's email score to 95. Similarly, a user's score for surfing the internet may be decreased if the user clicks on a link in a web site that is indicated as unsafe in a policy 233. Each of the users' scores described may be associated with a threshold and, if the threshold is breached, AU 315 may perform an action. For example, a threshold for an email score may be 55 and, if the score of a user is less than 55, AU 315 may force the user to complete an interactive training session that teaches how to exercise caution when using email. AU may force a user to participate in a training session, for example, if the user's score is less than a threshold as described, AU 315 may prevent the user from using email until the user has completed a tutorial or training session. Accordingly, using users' profiles 234, policies and a set of scores as described, AU 315 may provide user training that is specifically tailored for each user in an organization, this ability far exceeds the capability of a CISO. Of course, reverse logic may be used, e.g., an initial score may be set to 0 and each breach as described may cause AU 315 to increase (rather than decrease) the score, when the score's value reaches (or is above) a threshold, one or more actions may be performed as described.

A training session, lesson or tutorial may be automatically selected, e.g., by AU 315. For example, if a user's first score related to email is breached as described, AU 315 may automatically select, from training material 235, a training session related to using email, in another case, if a user's second score related to instant chat messaging is reaches or breaches, AU 315 may select a training session related to instant messaging.

In addition to selecting an action based on a score as described, AU 315 may select a training session (or other action) for a user based on an event and based on a user's profile. For example, if AU 315 detects a user has sent (or is about to send) an email containing sensitive information (an event), AU 315 may examine the user's profile, determine the user is a new employee or determine this is not the first time the user sends sensitive information in an email and select for the user a training session related to using email. In another example, an event may be connecting a USB stick the user's computer, in which case, AU 315 may force the user to complete a training related to using removable devices in the organization in order to use the USB device. In some embodiments, AU 315 may monitor the usage of a user's computer and, if no activity is detected, during a specific time interval while the screen of the computer is not locked, AU 315 may assume that the user left his computer without locking it and may, for example, change the user's score as described, present, to the user, a training related to securing (e.g., locking a desktop) and so on. An action taken by AU 315 may be, for example, forcing the user to participate in a training session before unlocking a computer. As described, an action of AU 315 may be according to a score or history. For example, the first time a user leaves his desktop unlocked, AU 315 may alert the user, the second time (during a predefined time interval) the user leaves his computer unlocked AU 315 may display a warning that prevents logging in for one minute and, the third time this happens AU 315 may lock the computer until the user completes a training session as described. Accordingly, an automatic selection of an action such as causing (or even forcing) a user to participate in (or complete) a training session may be based on the user's behavior, a score, a user's profile and an event.

An embodiment may apply a sanction, e.g., if an employee fails to complete a training directed to raising awareness when attaching files to emails, or the employee receives, in a quiz in the training, a score lower than a threshold, AU 315 may automatically prevent the employee from attaching files to emails until after the employee successfully completes the training. In another example, if AU 315 detects that an employee did not follow a link investigation procedure (e.g., hovering over the link and comparing its destination to the email domain name) than AU 315 may remove or disable all links in all emails of the employee, e.g., until after the employee successfully completes the relevant training

AU 315 may monitor completion of a training session and may record, e.g., in a user profile, whether or not the session was completed. AU 315 may record a score or mark related to the training session, e.g., AU 315 may record, in a user's profile, how many questions in a training session were answered correctly by the user. In some embodiments, AU 315 may calculate the time a user spent on each section in a training session and may compare the times to average, or predefined section times, if the user's average time is less than the average than AU 315 may assume the user did fully cooperated in completing the training and may decrease the user's score accordingly, thus, user's cooperation with training may be monitored and quantified and, accordingly, may take into account when selecting training or other actions for the user. Selecting a training session for a user may be based on how well the user did in a previous training session. For example, if a user fails an exam in a training session, AU 315 may force the user the complete that, or a different training session shortly after the training session and/or AU 315 may modify a security score of the user. Accordingly, an embodiment may tailor a specific training for each user based on how well the user is trained to avoid security risks. For example, if a user reports a real phishing email or the user carefully removes recipients who are not part of the organization from emails or avoids interacting with suspicious websites, AU 315 may change the user's score to reflect that the user is well aware of security risks. Accordingly, a score may be raised or lowered to reflect the level of awareness or a user to security risks. It is noted that an instance of AU 315 may be installed in each of (possibly a great number of) user computing device 210 in an organization, accordingly, embodiments of the invention enable training, and dramatically raising awareness, of users in an organization to security aspects where the training is specifically tailored for each user as described.

In some embodiments, AU 315 may receive, from ISS 325, information related to an action taken by ISS 325 with relation to the user and AU 315 may, based on the action taken by ISS 325, perform at least one of: inform a user regarding the action, guide the user on how to respond to the action, force the user to perform an action and prevent the user from performing an action.

For example, an AV unit included in ISS 325 may inform AU 315 that an email destined or addressed to a user has been blocked or quarantined because a virus included in the email was detected. In current systems and methods, this kind of event may go unnoticed for quite some time, e.g., not until the CISO examines logs of (or reports from) the AV system, will anyone in the organization know that the email was blocked. In some embodiments, AU 315 may communicate with the AV unit in ISS 325, learn that an email was blocked as described and inform the user, e.g., display on the user's screen a conversational chat bot that says “Mail from John Brown, with subject “Your inquiry” was blocked by AV”. Intervening as described may include modifying data. For example, AU 315 may modify a recipient list in an email about to be sent, e.g., AU 315 may remove, from a recipient list, all recipients who are not employees of an organization thus prevent data leakage or AU 315 may display a conversational chat bot that provides an explanation about email risks and/or guide a user, using natural language. For example, AU 315 may connect with a local Active Directory (AD) system and remove recipients with high/low permissions, or require the user to encrypt sensitive files or information before sending, e.g., to recipients who are not part of an organization, recipients who do not belong to a specific department and so on.

In another case or example, a firewall in ISS 325 may block the user from surfing to a specific web site, AU 315 may receive a message from the firewall informing AU 315 about the blocking indicating that visiting the website was prevented because it was recently published that the site contains malicious software, in such case, AU 315 may include or use a chat bot configured or adapted to present a message, on the user's screen, informing the user that visiting the site was prevented and why, thus, rather than suspecting something is wrong with his/her computer or web browser, the user is made aware why he/she cannot access the web site. As described, AU 315 may show the user training related to spotting malicious websites (e.g., looking for the HTTPs and the pad lock sign etc.). Accordingly, AU 315 may teach users how to spot security breaches and cyber issues and how to act when technical solutions fail to detect them. As described, teaching may be done in relation to an event thus teaching, as done by embodiments of the invention is far superior to teaching as currently known, e.g., teaching a user how to identify secure websites while the user is surfing the internet is far superior than teaching in a classroom or a lecture given to a department. As described, in connection to information received from ISS 325, AU may guide the user on how to respond to the action performed by ISS 325, force the user to perform an action and prevent the user from performing an action. For example, ISS 325 may prevent the user from accessing a file in a server, e.g., since the user does not have the required privileges, in such case, based on an “incorrect credential” message from ISS 325, AU 315 may inform the user that he/she needs to request (e.g., from the CISO) to change his/her privileges. AU 315 may automatically send a message to a CISO, e.g., requesting to approve a change of credentials. Embodiments may enable a CISO to set pre-defined actions, e.g., a request for a change of credentials may automatically cause the relevant AU 315 to select a training related to credentials for the user. In yet another example, e.g., if mail sent by the user was blocked (prevented from being sent) since it contained sensitive material, AU 315 may guide the user through recalling the email, removing an attachment and resending the email. It is noted that while, in some cases, messages from an ISS 325 may be provided to users, typically such messages are not really understood by users (who may not technically-inclined), using AU 315 as a mediator using natural language between users and ISS 325, embodiments of the invention greatly improve work flow in an organization by guiding users in responding to actions, events and messages originating at ISS 325. Generally described, AU 315 may act as a personal or private CISO that is seating beside a user and telling the user what he/she needs to do with respect to security of information and other cyber issues as described.

In some embodiments, AU 315 may receive, from ISS 325, information related to an action taken a user and AU 315 may, based on the action taken by user, perform at least one of: inform a user regarding the action, guide the user on how to respond to the action, force the user to perform an action and prevent the user from performing an action. For example, an attempt made by a user to access a protected file may be detected (and reported to AU 315) by a component in ISS 325, in response, AU 315 may perform any of the actions and/or operations as described, e.g., guide the user on what she/he needs to do in order to be permitted access, why access was denied and so on as described.

In some embodiments, AU 315 may automatically update a user's profile 234 based on information received from ISS 325. For example, based on a report from an AV program included in ISS 325 that indicates that a large number of viruses were found, e.g., in the last month, on a user's computing device, AU 315 may modify the score (or other data) in the user's profile 234 such that the constraints on the user reflect the fact that the user is highly exposed to malicious software. Automatically updating a user's profile 234 based on information received from ISS 325 may include recording, in the user profile 234, the number and type of viruses found on the user's computer, the documents affected by a virus in the computer, the number of email messages destined to the user and blocked and so on.

Accordingly, by collaborating with security entities in an organization, embodiments of the invention (e.g., AU 315) may dynamically and automatically change policies for specific users, change control of access to information and so on. For example, in the above example, informed that the user's computer 210 is infected by viruses, AU 315 may change the user's profile which, in turn, may cause restricting the user from accessing sensitive data in the organization, e.g., the user may be restricted from such access until s/he competes a relevant training session as described. For example, AU 315 may prevent users with a security score that is less than 70 from accessing a specific folder in a server of the organization, accordingly, informed of many viruses in a user's computer and decreasing the user's security score to less than 70 excludes the user from the group of users that can access the folder.

Accordingly, an embodiment may dynamically and automatically change users' privileges according to their behavior with respect to security, e.g., identifying that a user shows awareness to security of information, AU 315 may increase a score value of the user possibly causing the user to be able to access sensitive data that was previously inaccessible for the user, and, in another case, identifying that a user does not show sufficient awareness to security of information (e.g., tends to click on suspicious links, attaches sensitive information to emails sent outside the organization), AU 315 may decrease a score value of the user possibly causing the user to be unable to access sensitive data that was previously accessible for the user. It is noted that in current systems and methods, restricting access of a user based on finding viruses on her/his computer is done manually, that is, a CISO needs to be informed that viruses were found as described and then manually change the user's credentials, as described, in some embodiments of the invention, flow or process of identifying an infected computer and restricting access of the relevant user is fully automated and can be automatically done for each of thousands of users or employees in an organization.

As described, a reaction of an embodiment, e.g., to the fact that many viruses are detected on a user's computer may be guiding and training the user so that s/he is more aware of security. Any other aspect or indication that may point to the fact that a user is not sufficiently aware of security (e.g., recipient lists, attaching secret documents to email etc.) may cause an embodiment to act in order to raise or increase awareness to security as described. It is noted that monitoring and determining users' level of awareness may be continuous and changing users' scores may be continuous and dynamic, that is, AUs 315 of users in an organization may continuously monitor their respective users and dynamically, based on the monitoring, change their users' scores, consequentially, users' privileges may dynamically change as described and training sessions, reminders and warnings may be dynamically selected and/or executed, based on users' awareness to security of information as described.

In some embodiments, AU 315 may cause ISS 235 to modify rules or other information related to a user. For example, an organization AV program may be configured (e.g., initially or by default) to scan computing devices 210 for viruses once a week. Based on a user's score or profile as described, AU 315 may configure (change rules of) the AV program to scan the user's computing device once a day and, possibly, inform the user that many viruses are found on his/her machine. In another example, based on detecting the user often shares sensitive information in emails, AU 315 may configure an email server to apply strict rules to emails to/from the user, e.g., rules that are not normally applied, e.g., by a mail server, to other users in the organization e.g., a rule configured by AU 315 may prevent a user from sending or receiving attachments unless s/he successfully completes a relevant training or proves that s/he changed his/her behavior, e.g., by avoiding even an attempt to attach sensitive documents to emails for at least a month. Accordingly, instead of having a CISO manually configure an email server or an AV unit based on users' behavior or violations of security aspects (an overwhelming task in large organizations), embodiments of the invention enable automatic configuration of ISS 325 components, e.g., by AU 315 and based on automatic monitoring and profiling users with respect to security of information. AU 315 may automatically change users' permissions, credentials and the like thus, embodiments of the invention improve the field of security by automatically configuring security related entities (e.g., AV units, firewalls and servers) based on the level of risk posed by each user in the organization. The ability to configure, e.g., an AV system, such that it differently treats each of thousands of employees according to the level of risk associated with each of the employees (e.g., as reflected by their respective profiles and scores as described) will be readily appreciated by those having ordinary skill in the art. Causing an entity or unit in ISS 325 to modify rules for a user may be based on a user's profile and/or score. For example, if an email score of a user decreases below a threshold, AU 315 may configure an email server (e.g., server 330) to prevent the user from sending emails with attachments, or, in another case, if a score related to accessing sensitive documents decreases to a value below a threshold then AU 315 may configure a database (e.g., server 330) to prevent the user from accessing some folders (e.g., by excluding the user from a privileged group of users). Accordingly, configuring entities or units in ISS 325 may be based, or according to, a score or profile of a user. Another example of automatically configuring an entity in ISS 325 according to a behavior of a user may be the case where AU 315 configures a local web filtering unit to disable login from or via web pages for a user, e.g., in the case where an email client is a web based client and, based on the user's behavior, AU 315 selects to disable such logins.

In some embodiments, AU 315 may establish a (possibly direct) communication channel between some security management personnel (e.g., a CISO) and a user. For example, a set of AU 315 units may all be connected to an AU 315 in a computing device of a CISO thus enabling the CISO to broadcast a message to all users. For example, the CISO may publish a new training session by providing it to a set of AU 315s installed in a respective set of users' computing devices and the AU 315 units may use the new training session to train users as described. Similarly, a warning may be sent, by a CISO (e.g., a warning related to a new phishing attacks, virus or social attack) to the set of AU 315 units that may select how and when to warn users as described. AU 315 may autonomously and/or automatically cause a user to complete a training relevant to an attack, e.g., based on a report from an AV system informing of a virus, an AU 315 may select a training related to viruses or even related to the specific virus in the report from the AV system. Each AU 315 may monitor, cause or force completion of, a training session by its user and may further report back to the CISO, e.g., by reporting to the CISO AU 315. For example, each AU 315 may present a training session to its user, record responses to a quiz or other test or exam and report the results of the session to the CISO. Accordingly, a CISO may readily and easily cause and ensure a training session has been completed by all employees in an organization. AU 315 may report back if the user acknowledges a warning and/or update a score accordingly. Of course, based on completion or result, users' profiles may be updated as described. In some embodiments, results of a training session (e.g., a score determined based on the number of questions correctly answered) and/or failing to participate in a training session may be recorded in a user's profile, and, as described, restrictions related to security, e.g., permissions to access files or folders, browse the internet, receive email with attachment, may be modified or set based on the profile. Accordingly, embodiments of the invention enable automatic update or modification of users' credential or privileges based on the users' level of training. Any aspect related to an interaction or participation with a training session or material may be recorded. For example, each AU 315 may record a result of a training session or article published as described by recording whether or not a user read an entire article, confirmed having read the article, the time it took for the user to read an article, complete the training or quiz and the like. By providing a direct channel between a CISO and each user as described, embodiments of the invention enable a CISO to easily launch training campaigns and further measure the level of participation and effectiveness of the campaigns. In some embodiments, AU 315 may be connected to a 3^{rd} party warning system and may automatically send an employee a warning, that may be selected based on the employee's job function e.g., if the employee is working in a service center with no web browsing permissions AU 315 received warning regarding a web attack, AU 315 may exclude the employee from those receiving the warning. In another case, by AU 315 monitoring a user's activity as described, AU 315 may identify the user never receives Excel format file attachments, thus, if a warning related to a vulnerability in Excel files is received, AU 315 may select not to alert the user. Accordingly, embodiments of the invention may personalize warnings and other actions by selecting to warn a user only where or when a warning is relevant thus avoiding redundantly disturbing users.

As described, in some embodiments, AU 315 may establish a direct communication channel between ISS 325 and a user. For example, and as described, messages, events and other information originating at ISS 325 may be provided to users by AU's 315, accordingly, a communication channel between ISS 325 and users is established. For example, AU 315 may receive, e.g., from an AV system or a 3^{rd} party unit, notifications related to a user and provide the notifications, possibly adding (or using) natural-language chat-bot explanations and/or training material, to the user. For example, as known in the art, an AV may generate a message that merely includes an error or warning number, such number may be translated or converted, by AU 315, to simple text and the simple text may be presented to the user. AU 315 may monitor a user's reaction to this communication (or change of behavior) and may update the user's profile according to the user's reaction to, or interaction with a warning or other material presented. For example, a score of the user may be modified, by AU 315, based on whether the user acknowledged a warning, took more than a minute to read a warning (or immediately closed a window or popup containing the warning), actually scrolled all the way down to the end of the warning and so on. Accordingly, embodiments of the invention may modify users' profile (and consequently, based on their profiles, select how to train the users) based on any indication of users' awareness to security of data including the importance that users attribute to security of information, e.g., the way a user treats a warning as describe (e.g., reads it through or ignores it) is used by AU 315 as input for determining how important the user thinks security is, and, as described, based on the user's view of security, AU 315 may select how to train the user with respect to security.

As described, AU 315 may do more than just conveying messages from ISS 325 to users, e.g., AU 315 may add explanations to messages or events, guide a user in solving a problem reported by ISS 325 (e.g., fix credentials or permissions, move files to a less secured folder and the like).

In some embodiments, AU 315 may intervene in an interaction of a user with computing device 210 if the interaction violates a security policy or aspect. AU 315 may explain (e.g., a natural language chat-bot) to the user what is the cause and propose of the intervention. For example, AU 315 may examine an email composed by the user and, if sensitive information is detected therein, AU 315 may prevent the user from sending the email. For example, detecting a phone number of an executive in the organization in an email about to be sent may cause AU 315 to display a message or warning to the user urging the user to consider whether or not to disclose the phone number in the email. As described, selecting whether to just warn a user or to actually prevent the user from sending the email may be based on the user's profile. Accordingly, an intervention may be according to a user's profile, e.g., according to a score in the user's profile as described.

In addition to intervening as described, AU 315 may provide guidance, e.g., in the above mail example, AU 315 may guide a user how to send sensitive emails, e.g., check the recipient list, verify that all recipients indeed need to be provided with a document being attached to the email and so on, accordingly, intervening may be combined with guiding aimed at educating users with respect to security.

In another example, AU 315 may detect a document containing sensitive information (e.g., financial or private information) is attached to an email composed by a user and AU 315 may warn the user of attaching the document. In yet other examples, AU 315 may prevent sending or sharing information. For example, AU 315 may be, or it may activate a plug-in installed in an email application and may prevent sending an email that includes sensitive information. AU 315 may disable a user from preforming some actions according to a location. e.g., AU 315 may prevent the user from opening specific files (e.g., ones containing sensitive information) or using a sensitive internal application according to the user GEO location, e.g., AU 315 may permit the user to open the specific files when the user is physically in the organization's premises but AU 315 may prevent opening the files when the user is working from home. In another case, depending on the kind of network used (e.g., a secured or non-secure virtual private network (VPN), AU 315 may enable or prevent accessing specific files or data or performing specific operations, e.g., sending email etc. Detecting risky behavior related to a location may cause AU 315 to select a training related to working from remote locations, e.g., a training that explains the risks involved with working over unprotected networks, carrying detachable devices out of an organization and the like.

In some embodiments, SU 315 may modify a graphical user interface (GUI) object in an application according to a security consideration. For example, AU 315 may disable a GUI object thus disabling an action. For example, to prevent a user from sending an email that includes sensitive information, or sending such email to recipients who are not known to be authorized to view the sensitive information, AU 315 may disable (e.g., dim) the send button in an email application. In addition to disabling a button or otherwise preventing a user from performing an action or completing a task, AU 315 may provide the user with an explanation, tutorial or guidance. For example, in addition to dimming a GUI send button as described, AU 315 (e.g., in a capacity of a chat bot) may display a message informing the user why the button was dimmed or disabled and further providing suggestions or hints. For example, if document document.docx attached to an email about to be sent to John Brown is the reason AU 315 prevents a user from sending the email then AU 315 may display a message saying “Document.docx includes information that should not be sent to John Brown who is not an employee of this organization”. Any aspect of a communication may cause AU 315 to intervene in an action, interaction or task of a user, e.g., the content being communicated, the intended recipients of the content (e.g., are the intended recipient's part or employees of the organization, are the recipients included in a list or policy allowing them to receive sensitive information and so on). In another example, AU 315 may disable or dim the “connect to network” icon on a computer screen if it identifies that the network about to be connected to is unsecure or the user is out of the organization's premise.

AU 315 may intervene in an interaction or communication based on information received for a user. For example, AU 315 may block an incoming email message or it may prevent a user from opening, or interacting with an incoming email message. For example, if AU 315 suspects that an incoming email message includes phishing objects (e.g., links, attachments or call for action requests), AU 315 may prevent opening or interacting with the message (e.g., prevent mouse clicks in the message body) and AU 315 may further present a message to the user, e.g., a message saying “This email message might include phishing objects, please do not interact with this message and report it to the CISO”. Any guidance, suggestions or tips may be presented or provided to a user, by AU 315, in addition to blocking or preventing an interaction of a user with an application as described.

In some embodiments, AU 315 may prevent a user from performing an action or completing a task unless, or until, the user successfully completes a training session. For example, AU 315 may prevent a user from sending text messages unless, or until, the user successfully completes a training session related to instant messaging or chat applications. Successful completion of a training session may be, or may include, reading text, answering questions or participating in an interactive session, e.g., a session that includes presenting situations to a user and evaluating the user's response to the situations or events.

In some embodiments, AU 315 may chat with a user to provide the user with guidance related to security issues. For example, AU 315 may operate as a chat bot providing information, suggestions and guidance, e.g., how to ensure private or sensitive information is not leaked out of an organization, how to avoid interacting with unsecured links or content in the internet and so on. As described, a chat with a user performed by AU 315 may be based on the user's profile and/or actions, e.g., if AU 315 identifies that a user that tends to indiscriminately click links in the internet then AU 315 may start a chat with the user explaining the danger in clicking links. A chat between a user and AU 315 may be invoked by a user enabling the user to ask questions and receive answers and guidance as described. Another example of a chat connection or session includes enabling a user to ask a chat-bot (that, as described, may be, or may be included in AU 315) questions. For example, a user may ask AU 315 (acting as a chat bot) if any of her/his emails were quarantined in the last 24 hours or six days and AU 315 may check with an entity in ISS 325 and provide relevant answers, or AU 315 acting as a chat-bot may, in response to a question from a user, provide the user with a status or report related to suspicious email correspondence in the last week. In another example, a user may ask AU 315 what is the reason his/her computer runs slowly and AU 315 may check with 3^{rd} parties' solutions (e.g. AV) and explain to the user the reason and describe the actions or steps the user need to do to fix the problem.

In some embodiments, AU 315 may remind a user to perform an action related to a security threat caused by an action of the user. For example, AU 315 may detect the user has sent a document to a printer and AU 315 may set an internal timer (e.g., for 10 minutes) and, when the timer expires, AU 315 may remind (e.g., using a chat-bot or popup as described) remind the user to pick up the printed document from the printer thus reducing the risk of sensitive printed material being obtained by an entity it is not meant for.

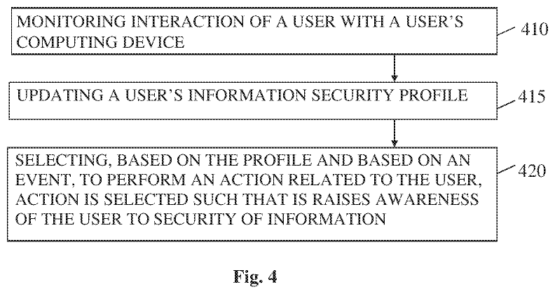

Reference is now made to FIG. 4 which shows a flowchart of a method according to illustrative embodiments of the present invention. As shown by block 410, interaction of a user with a computing device may be monitored, e.g., AU 315 monitors interaction of a user with a computer by, for example, identifying mouse clicks (and what is being clicked on), examining emails, identifying clicks on links etc. As shown by block 415, a user's profile may be updated e.g., according to the monitoring. For example, AU 315 monitors user's actions and interactions and updates a user profile 234 as described. As shown by block 420, based on the profile and based on an event, an action may be selected such that it raises awareness of the user to security of information. For example, based on a user's profile 234 and based on an event (e.g., reception of an email message, surfing to a web site), AU 315 may perform an action such as warning a user of a risk. For example, automatically selecting an action to perform, based on a profile and based on an event may include selecting, for a first user, an action that includes intervening with the first user's interaction with a computer if the user's score indicates that the user is highly susceptible to phishing and selecting, for a second user, an action that merely warns the user of a possible risk, e.g., if the second user's profile indicates the second user is typically careful when operating his/her computer.

It is noted that the same event, e.g., reception of a specific, same email message, by both first and second users may cause an embodiment to take or select different actions for the first and second users, e.g., since their respective profiles indicate that their respective susceptibilities to phishing or other threats are different, for example, when a first user connects a USB device to his computer and embodiment may prevent copying files from some folders to the USB device but when another (second) user connects a USB device to her computer an embodiment may only warn the user that some files are best not copied to the USB device and/or carried outside the organization. Such different actions for different users may be selected, as described, based on a specific event, e.g., based on the kind or level or risk introduced by an action of the user and further based on the user's profile, e.g., a scorer of the user as described.

In the description of the present application, each of the verbs, “comprise” “include” and “have”, and conjugates thereof, are used to indicate that the object or objects of the verb are not necessarily a complete listing of components, elements or parts of the subject or subjects of the verb.

Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Some embodiments utilize only some of the features or possible combinations of the features. Variations of embodiments of the invention that are described, and embodiments comprising different combinations of features noted in the described embodiments, will occur to a person having ordinary skill in the art. The scope of the invention is limited only by the claims.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A system comprising:
a memory; and
a controller adapted to:
monitor interaction of a user with a user's computing device to update a user's information security profile; and
select, based on the profile and based on an event, to perform an action related to the user, wherein the action is selected such that is raises the awareness of the user to security of information.

2. The system of claim 1, wherein the controller is further adapted to:
receive, from an information security system (ISS), information related to an action taken by the user or by the ISS with relation to the user; and
based on the action, perform at least one of: inform the user regarding the action, guide the user in responding to the action, force the user to perform an action and prevent the user from performing an action.

3. The system of claim 1, wherein the controller is further adapted to select, based on an event and based on the profile, a training session for the user.

4. The system of claim 1, wherein the controller is further adapted to present and monitor completion of a security training session, the training session designed to raise the user's awareness to security, and update the profile based a result of the session.

5. The system of claim 1, wherein the controller is further adapted to update the profile according to information obtained from an ISS.

6. The system of claim 1, wherein the controller is further adapted to intervene in an interaction of the user with the computing device based on at least one of: a violation of a security policy, information received, information about to be sent, a user's profile and a user's score

7. The system of claim 1, wherein the action is selected based on:
a score included in the profile; and
an event including at least one of: reception of a message and an interaction of a user with a computing device.

8. The system of claim 1, wherein the controller is further adapted to chat with a user and provide guidance related to security issues.

9. The system of claim 1, wherein the controller is further adapted to cause an ISS to modify rules related to the user.

10. The system of claim 1, wherein the controller is further adapted to remind the user to perform an action related to a security threat caused by an action of the user.

11. The system of claim 1, wherein the controller is further adapted to modify a graphical user interface (GUI) object in an application according to a security consideration.

12. The system of claim 1, wherein the controller is further adapted to establish a communication channel between at least one of: a security management personnel and a user, and an ISS and the user.

13. The system of claim 1, wherein the controller is included in the user's computing device.

14. A method of securing electronic correspondence, the method comprising:
monitoring interaction of a user with a user's computing device to update a user's information security profile; and
selecting, based on the profile and based on an event, to perform an action related to the user,
wherein the action is selected such that is raises the awareness of the user to security of information.

15. The method of claim 14, further comprising:
receiving, from an information security system (ISS), information related to an action taken by the user or by the ISS with relation to the user; and
based on the action, performing at least one of: informing the user regarding the action, guiding the user in responding to the action, forcing the user to perform an action and preventing the user from performing an action.

16. The method of claim 14, comprising, selecting, based on an event and based on the profile, a training session for the user.

17. The method of claim 14, comprising, presenting and monitoring completion of, a security training session, the training session designed to raise the user's awareness to security, and updating the profile based a result of the session.

18. The method of claim 14, comprising, updating the profile according to information obtained from an ISS.

19. The method of claim 14, comprising, intervening in an interaction of the user with the computing device based on at least one of: a violation of a security policy, information received by the user, information about to be sent by the user, a user's profile and a user's score.

20. A method of increasing awareness of a user to security of information, the method comprising:
monitoring interaction of a user with a user's computing device;
identifying an action of a user as risky;
selecting a training session for the user; and
causing the user to complete the training session.
